(19) United States
(12) Patent Application Publication
(10) Pub. No.: US 2026/0340745 A1
(43) Pub. Date: Oct. 29, 2026

(54) SYSTEMS AND METHODS FOR DYNAMIC OUTCOME VARIABLE ESTIMATION VIA MACHINE-LEARNING-BASED FEATURE TRANSFORMATION

(71) Applicant: Canotera LTD, Haifa (IL)

(72) Inventors: David H. Silver, Poughkeepsie, NY (US); Tal Knafo, Haifa (IL)

(73) Assignee: Canotera LTD, Haifa (IL)

(21) Appl. No.: 19/447,576

(22) Filed: Jan. 13, 2026

Related U.S. Application Data
(60) Provisional application No. 63/744,494, filed on Jan. 13, 2025.

(51) Int. Cl. G06Q 50/18; G06F 40/226; G06N 20/00

(52) U.S. Cl. CPC G06Q 50/18; G06F 40/226; G06N 20/00

(57) ABSTRACT

A system and method for processing documents to generate an output file is presented. The method includes receiving documents; parsing the documents to generate a normalized text representation, wherein the normalized text representation includes ordered text spans, each ordered text span associated with a provenance pointer identifying an originating document; storing a versioned snapshot; constructing a heterogeneous graph representation based on the normalized text representation, wherein the heterogeneous graph representation includes nodes and edges; performing relation-aware message passing on the heterogeneous graph representation to generate a learned representation; generating a model output by applying a predictive model to the learned representation; calibrating the model output to generate a calibrated probability vector; generating an outcome prediction for the matter based on the learned representation and the calibrated probability vector; and generating the output file as a prediction package that includes the outcome prediction and versioned snapshot.

### CROSS REFERENCE TO RELATED APPLICATION

This application claims the benefit of U.S. Provisional Application No. 63/744,494, filed Jan. 13, 2025, the contents of which are hereby incorporated by reference.

### TECHNICAL FIELD

The present invention relates to the field of procedural data management systems and artificial intelligence, specifically to systems and methods for computational estimation of future event state variables using advanced mathematical models augmented with neural-symbolic architectures and graph-based learning.

### BACKGROUND

Legal matters typically involve large volumes of heterogeneous, case-related documents (e.g., pleadings, motions, orders, docket entries, opinions, exhibits) originating from multiple sources and varying widely in formatting, structure, and content quality. Conventional approaches to legal analytics often rely on ad hoc parsing and feature extraction that do not preserve fine-grained provenance from derived text to source artifacts, making downstream predictions difficult to audit, reproduce, or explain. Further, legal documents frequently contain sensitive information, and naive processing pipelines can increase re-identification risk or require withholding useful information. Even where predictive models are employed, raw model outputs are often miscalibrated and do not provide explicit coverage guarantees and provenance of the methods, underlying data used in the determination, which can lead to overconfident or misleading outputs in high-stakes legal settings.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by data processing apparatus, cause the apparatus to perform the actions.

In one general aspect, the method may include receiving a plurality of legal documents as electronic files that are associated with a legal matter. The method may also include parsing the plurality of legal documents to generate a normalized text representation, where the normalized text representation includes ordered text spans, each ordered text span associated with a span identifier and a provenance pointer identifying an originating legal document among the plurality of legal documents; storing a versioned snapshot of the normalized text representation together with a timestamp and a content hash; constructing a heterogeneous graph representation based on the normalized text representation, where the heterogeneous graph representation includes a plurality of nodes and a plurality of edges, where the plurality of nodes represent document structure and legal entities, and where the plurality of edges represent citations and timeline relationships between the plurality of nodes; performing relation-aware message passing on the heterogeneous graph representation to generate a learned representation; generating a model output by applying a predictive model to the learned representation; calibrating the model output to generate a calibrated probability vector; generating an outcome prediction for the legal matter based on the learned representation and the calibrated probability vector; and generating the output file as a prediction package that includes the outcome prediction and the content hash. Other embodiments of this aspect include corresponding computer systems, apparatus, and computer programs recorded on one or more computer storage devices, each configured to perform the actions of the methods.

Implementations may include one or more of the following features. The method may include detecting a sensitive span in the normalized text representation; classifying a redaction type for the sensitive span generating surrogate tokens based on the redaction type; and replacing the sensitive span with the surrogate tokens; generating an entity identifier in response to the sensitive span including an entity; generating a mention identifier, where the mention identifier represents a location of the sensitive span; and storing a mapping between the entity identifier and a sensitive span value in a secure vault, where access to the secure vault is subject to a control policy and audit logging.

The method where the plurality of nodes includes at least one document node type and at least one structural unit node type corresponding to the ordered text spans, and the plurality of edges may include at least one citation edge type representing that a first node cites a second node, and at least one temporal edge type representing that a third node at a first time precedes a fourth node at a second time. The method may include computing a first transformed message by applying a first transform to messages propagated along citation relationships represented by a first subset of the plurality of edges; computing a second transformed message by applying a second transform to messages propagated along timeline relationships represented by a second subset of the plurality of edges; and aggregating, for a node, the first transformed message and the second transformed message using attention weights computed from node representations and edge attributes; defining a prediction target label space having a plurality of outcome labels for the legal matter, where generating the model output may include generating a logit vector having a respective logit value for each outcome label in the prediction target label space; calibrating the model output may include converting the model output to an uncalibrated probability vector using a normalization transform and applying a calibration mapping to generate the calibrated probability vector; and generating a coverage-controlled prediction set based on the calibrated probability vector and a target coverage parameter, and where the prediction package includes an inclusion indicator for whether a candidate label is included in the coverage-controlled prediction set; identifying timestamps in the plurality of legal documents, where the timestamps correspond to filing date; weighting the normalized text representation based on the filing date; and generating a matter timeline by ordering docket events based on extracted filing dates and linking each docket event to at least one provenance pointer; generating a counterfactual report by modifying at least one component of the heterogeneous graph representation; recomputing a counterfactual calibrated probability vector; computing a difference between the calibrated probability vector and the counterfactual calibrated probability vector; and including the difference in the output file. Implementations of the described techniques may include hardware, a method or process, or a computer tangible medium.

In one general aspect, non-transitory computer-readable medium may include one or more instructions that, when executed by one or more processing circuitries of a device, cause the device to: receive a plurality of legal documents as electronic files that are associated with a legal matter; parse the plurality of legal documents to generate a normalized text representation, where the normalized text representation includes ordered text spans, each ordered text span associated with a span identifier and a provenance pointer identifying an originating legal document among the plurality of legal documents; store a versioned snapshot of the normalized text representation together with a timestamp and a content hash; construct a heterogeneous graph representation based on the normalized text representation, where the heterogeneous graph representation includes a plurality of nodes and a plurality of edges, where the plurality of nodes represent document structure and legal entities, and where the plurality of edges represent citations and timeline relationships between the plurality of nodes; perform relation-aware message passing on the heterogeneous graph representation to generate a learned representation; generate a model output by applying a predictive model to the learned representation; calibrate the model output to generate a calibrated probability vector; generate an outcome prediction for the legal matter based on the learned representation and the calibrated probability vector; and generate the output file as a prediction package that includes the outcome prediction and the content hash. Other embodiments of this aspect include corresponding computer systems, apparatus, and computer programs recorded on one or more computer storage devices, each configured to perform the actions of the methods.

In one general aspect, the system may include a processing circuitry. The System may also include a memory, the memory containing instructions that, when executed by the processing circuitry, configure the system to receive a plurality of legal documents as electronic files that are associated with a legal matter; parse the plurality of legal documents to generate a normalized text representation, where the normalized text representation includes ordered text spans, each ordered text span associated with a span identifier and a provenance pointer identifying an originating legal document among the plurality of legal documents; store a versioned snapshot of the normalized text representation together with a timestamp and a content hash; construct a heterogeneous graph representation based on the normalized text representation, where the heterogeneous graph representation includes a plurality of nodes and a plurality of edges, where the plurality of nodes represent document structure and legal entities, and where the plurality of edges represent citations and timeline relationships between the plurality of nodes; perform relation-aware message passing on the heterogeneous graph representation to generate a learned representation; generate a model output by applying a predictive model to the learned representation; calibrate the model output to generate a calibrated probability vector; generate an outcome prediction for the legal matter based on the learned representation and the calibrated probability vector; generate the output file as a prediction package that includes the outcome prediction and the content hash.

Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to detect a sensitive span in the normalized text representation; classify a redaction type for the sensitive span; generate surrogate tokens based on the redaction type; and replace the sensitive span with the surrogate tokens.

The system where the memory contains further instructions which when executed by the processing circuitry further configure the system to: generate an entity identifier in response to the sensitive span including an entity; generate a mention identifier, where the mention identifier represents a location of the sensitive span; and store a mapping between the entity identifier and a sensitive span value in a secure vault, where access to the secure vault is subject to a control policy and audit logging.

The system where the one or more processors, when the plurality of nodes includes at least one document node type and at least one structural unit node type corresponding to the ordered text spans, and the plurality of edges, are configured to at least one citation edge type represent that a first node cites a second node, and at least one temporal edge type representing that a third node at a first time precedes a fourth node at a second time.

The system where the memory contains further instructions which when executed by the processing circuitry further configure the system to: compute a first transformed message by applying a first transform to messages propagated along citation relationships represented by a first subset of the plurality of edges; compute a second transformed message by applying a second transform to messages propagated along timeline relationships represented by a second subset of the plurality of edges; and aggregate, for a node, the first transformed message and the second transformed message using attention weights computed from node representations and edge attributes.

The system where the memory contains further instructions, which when executed by the processing circuitry, further configure the system to: define a prediction target label space having a plurality of outcome labels for the legal matter, where generating the model output may include generating a logit vector having a respective logit value for each outcome label in the prediction target label space.

The system where the memory contains further instructions which when executed by the processing circuitry further configure the system to: calibrate the model output may include converting the model output to an uncalibrated probability vector using a normalization transform and applying a calibration mapping to generate the calibrated probability vector; and generate a coverage-controlled prediction set based on the calibrated probability vector and a target coverage parameter, and where the prediction package includes an inclusion indicator for whether a candidate label is included in the coverage-controlled prediction set.

The system where the memory contains further instructions which when executed by the processing circuitry further configure the system to: identify timestamps in the plurality of legal documents, where the timestamps correspond to filing date; weight the normalized text representation based on the filing date; and generate a matter timeline by ordering docket events based on extracted filing dates and linking each docket event to at least one provenance pointer.

The system where the memory contains further instructions, which when executed by the processing circuitry, further configure the system to: generate a counterfactual report by modifying at least one component of the heterogeneous graph representation; recompute a counterfactual calibrated probability vector; compute a difference between the calibrated probability vector and the counterfactual calibrated probability vector; and include the difference in the output file. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example system diagram of a computing environment, utilized to describe an embodiment.

FIG. 2 is a diagram illustration of hierarchical heterogeneous graph schema 200, implemented in accordance with an embodiment.

FIG. 3 is a diagram illustration of user interface views 300, implemented in accordance with an embodiment.

FIG. 4 is an example flowchart of a method for processing case-related electronic documents to generate an output file, implemented in accordance with an embodiment.

FIG. 5 is an example processing pipeline, implemented in accordance with an embodiment.

FIG. 6 is an example schematic diagram of an intake engine 110 according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

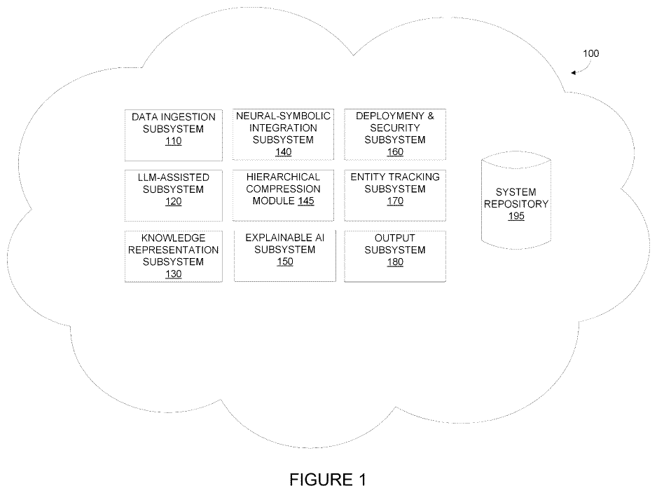

FIG. 1 is an example system diagram of a computing environment.

In some embodiments, the analytics system 100 includes an intake engine 110, a matter repository 115, a privacy engine 120, a structure engine 130, a graph construction engine 140, an embedding engine 150, a graph learning engine 160, an entity tracking engine 165, a prediction engine 170, a calibration engine 175, a text prediction engine 180, a conformal text engine 185, an explanation engine 190, an output assembly engine 195, various combinations thereof, and the like.

In an embodiment, an intake engine 110 is configured to generate a matter record for a target legal matter based on one or more incoming legal sources.

In some embodiments, the incoming legal sources include one or more legal source endpoints, legal source artifacts, including one or more of (i) electronic court filing systems, docketing systems, and court calendar services, (ii) document repositories and matter management systems, (iii) electronic mail or secure message inboxes configured to receive legal documents, and (iv) retrieved legal documents and records such as docket entries, pleadings, motions, exhibits, declarations, discovery materials, court orders, judicial opinions, statutes, common law, regulations, administrative decisions, transcript records, and judge profiles, or any combination thereof.

In some embodiments, the legal sources include a plurality of legal documents. In some embodiments, the plurality of legal documents are received as electronic files.

In some embodiments, the intake engine 110 receives, from the one or more incoming legal sources, a matter initiation payload comprising structured matter context attributes associated with the target legal matter.

In some embodiments, the intake engine 110 is configured to generate the matter initiation payload by aggregating structured fields received from the one or more incoming legal sources and, when one or more fields are missing or uncertain, extracting candidate values from one or more incoming legal source artifacts using one or more of optical character recognition (OCR), document parsing, and pattern-based field extraction, and then normalizing the candidate values into the canonical schema.

In some embodiments, the matter context attributes are obtained from structured fields provided by a source endpoint, extracted from unstructured legal documents using document parsing operations, extracted using optical character recognition, a combination thereof and the like.

In some embodiments, the matter initiation payload specifies matter context attributes including a jurisdiction, a venue, a tribunal identifier, a case number, a filing date, a judge identifier, a party role descriptor, a procedural posture descriptor, a target event type, a combination thereof and the like.

In some embodiments, the intake engine 110 is configured to validate the matter initiation payload by checking required fields, normalizing field formats using a canonical schema, rejecting malformed values based on schema constraints, and storing a versioned snapshot of the validated matter initiation payload in a matter repository 115 together with a timestamp, a content hash, and an intake identifier.

In some embodiments, the intake engine 110 is configured to ingest one or more legal source artifacts and to populate the matter record with normalized source metadata, identify a set of source endpoints based on the matter initiation payload, authenticate each endpoint using scoped credentials, retrieve the legal source artifacts using deterministic retrieval parameters, and store the retrieved legal source artifacts in the matter repository 115 referenced by the intake identifier, a combination thereof and the like.

In some embodiments, the intake engine 110 is configured to perform acquisition quality assurance operations for each retrieved legal source artifact prior to canonicalization and prior to inclusion in downstream processing. In some embodiments, the acquisition quality assurance operations include validating a file format identifier and a MIME type value against an allowed type policy, verifying file integrity using one or more checksums, rejecting corrupted artifacts that fail parseability checks, detecting password-protected or encrypted artifacts and routing such artifacts to an exception workflow subject to an authorization policy, and storing an acquisition status indicator in association with the source artifact descriptor, a combination thereof and the like.

In some embodiments, the intake engine 110 is configured to perform de-duplication across retrieved legal source artifacts using one or more document fingerprinting operations. In some embodiments, the intake engine 110 computes a near-duplicate signature for an artifact by generating a canonical text preview using one or more of document parsing operations and optical character recognition (OCR), then computing a SimHash signature over token shingles derived from the canonical text preview, a combination thereof and the like. In some embodiments, the intake engine 110 determines that a retrieved artifact is a duplicate or near-duplicate by comparing the Sim Hash signature to previously stored signatures within a matter scope and declaring a match when a Hamming distance satisfies a deduplication threshold. In some embodiments, when a duplicate or near-duplicate is detected, the intake engine 110 is configured to (i) store a single canonical instance of the artifact and associate additional retrieval events with the same source artifact descriptor, (ii) store a duplicate reference record that links a duplicate artifact identifier to an original artifact identifier together with retrieval timestamps and source endpoint identifiers, or (iii) exclude the duplicate artifact from canonicalization while retaining a chain-of-custody record for auditability, a combination thereof and the like.

In some embodiments, the legal source artifacts include docket entries, pleadings, motions, exhibits, declarations, discovery materials, court orders, judicial opinions, statutes, common law, regulations, administrative decisions, transcript records, judge profiles, court calendars, a combination thereof and the like. For each retrieved legal source artifact, the intake engine 110 is configured to generate a source artifact descriptor that includes a source endpoint identifier, a retrieval timestamp, a document fingerprint, a file format identifier, a chain-of-custody record, linkage to the matter record, a combination thereof and the like.

In some embodiments, the matter record comprises one or more structured matter context fields from the matter initiation payload, one or more pointers to versioned snapshots of the matter initiation payload, one or more source artifact descriptors for retrieved legal source artifacts, and one or more canonical text packages derived from the retrieved legal source artifacts, a combination thereof and the like.

In some embodiments, the intake engine 110 is configured to canonicalize each legal source artifact into a normalized text representation stored as part of the matter record.

In some embodiments, the canonicalization includes parsing each legal source artifact into an intermediate representation by extracting raw text, layout cues, and section boundaries, performing cleanup operations that include removing non-semantic boilerplate, normalizing whitespace, standardizing numbering tokens, converting typographic variants into canonical characters, a combination thereof and the like.

In some embodiments, the intake engine 110 is configured to segment the intermediate representation into ordered text spans using structural rules that detect headings, captions, paragraph boundaries, and citation blocks, stores the ordered text spans as a canonical text package associated with the source artifact descriptor, a combination thereof and the like. In some embodiments, the intake engine 110 is configured to assign each text span a span identifier, an offset range, a parent section identifier, and a provenance pointer to the originating legal source artifact.

In some embodiments, the intake engine 110 is configured to populate matter context fields by extracting structured metadata from the canonical text package and from the matter initiation payload. The intake engine 110 extracts docket-level metadata by locating caption fields, signature blocks, service certificates, and docket headers, then determining normalized values by applying pattern rules for case numbers, court identifiers, party labels, counsel identifiers, filing dates, motion titles, a combination thereof and the like.

In some embodiments, the intake engine 110 is configured to extract citation metadata by detecting citation strings, normalizing reporter abbreviations into canonical reporter labels, normalizing pin cites into a uniform format, and storing each citation as a citation record that includes a cited authority identifier, a citation text span reference, a citation type label, a combination thereof and the like.

For example, the intake engine 110 stores in the matter record a matter timeline generated by ordering docket events based on extracted filing dates and docket sequence identifiers, then linking each event to one or more source artifact descriptors and one or more canonical text packages.

In some embodiments, a privacy engine 120 is configured to transform the canonical text package into a de-identified canonical text package. In some embodiments, the de-identified canonical text package preserves deterministic, document-scoped referential consistency.

In some embodiments, the privacy engine 120 is configured to retrieve the ordered text spans for a source artifact descriptor together with span identifiers. In some embodiments, the privacy engine 120 is configured to scan each text span to detect masked content and sensitive content using one or more redaction detectors. The redaction detectors evaluate each text span using pattern rules that identify bracketed masks, black-bar artifacts represented as replacement glyph sequences, repeated asterisk sequences, and placeholder tokens, a combination thereof and the like.

In some embodiments, the redaction detectors further evaluate each text span using a learned sequence tagger that labels character ranges as sensitive spans based on lexical features, formatting markers, and surrounding context windows derived from adjacent text spans in the same source artifact descriptor.

In some embodiments, the privacy engine 120 is configured to classify each detected sensitive span into a redaction type. In some embodiments, the redaction type is based on redaction features. In some embodiments, the redaction features include neighboring words, punctuation shape features, capitalization patterns, caption proximity, signature-block proximity, and citation-block exclusion signals, a combination thereof and the like, then mapping the redaction features to a controlled vocabulary that includes PERSON, ORGANIZATION, ADDRESS, PHONE, EMAIL, ACCOUNT, DATE, CASE_NUMBER, RECORD_IDENTIFIER, a combination thereof and the like.

In some embodiments, the privacy engine 120 is configured to replace the detected sensitive span with a deterministic surrogate token scoped to the source artifact descriptor. For example, the privacy engine 120 assigns CASE_NUMBER when a sensitive span corresponds to the case number extracted from caption fields and docket headers and assigns RECORD_IDENTIFIER when a sensitive span corresponds to a non-case identifier value that identifies a record in a data system.

In some embodiments, the privacy engine 120 is configured to generate a document identifier for the source artifact descriptor. In some embodiments, the document identifier is a fixed-length identifier from a document fingerprint stored in the source artifact descriptor.

In some embodiments, the privacy engine 120 is configured to initialize a per-document per-type counter table keyed by the document identifier and the redaction type label. The privacy engine 120 increments the counter table for a given redaction type label to allocate a document-scoped index and generates the surrogate token by concatenating the redaction type label, the document identifier, and the document-scoped index, thereby preventing token collisions across documents by construction. For example, the surrogate token is formatted as ENT_PERSON_DOCA1B2_0007, ENT_ORGANIZATION_DOCA1B2_0012, a combination thereof and the like. In some embodiments, “PERSON” is an example of the redaction type label and “ENT_” is an example of a surrogate token prefix.

In some embodiments, the privacy engine 120 is configured to replace the sensitive span in the canonical text package with the surrogate token.

In some embodiments, the privacy engine 120 is configured to store a redaction record in the matter repository 115. In some embodiments, the redaction record includes the span identifier, a character offset range, the redaction type label, the surrogate token, a provenance pointer to the source artifact descriptor, a combination thereof and the like.

In an embodiment, the privacy engine 120 is configured to generate a non-personally identifiable information EntityID that represents an underlying entity across repeated mentions while remaining independent of mention-specific coordinates.

In some embodiments, the privacy engine 120 is configured to construct an EntityID payload by concatenating a matter identifier, a tribunal identifier, the redaction type label, and a normalized surface form derived from the sensitive span value before replacement, a combination thereof and the like. In some embodiments, the privacy engine 120 is configured to generate the normalized surface form by applying case folding, punctuation canonicalization, whitespace normalization, abbreviation expansion using a legal abbreviation dictionary, and script normalization, a combination thereof and the like.

In some embodiments, the privacy engine 120 is configured to construct the EntityID by applying a keyed cryptographic function to the EntityID payload, including an HMAC computation using a secret key stored in a secure key store, truncating the resulting digest to a fixed-length identifier representation, a combination thereof and the like.

In some embodiments, the privacy engine 120 stores the EntityID in the redaction record together with the surrogate token, thereby enabling downstream components to reference a stable entity representation without using the sensitive span value.

In some embodiments, the privacy engine 120 is configured to generate a MentionID for each occurrence of a replaced sensitive span.

In some embodiments, the privacy engine 120 is configured to construct a MentionID payload that includes the EntityID, the span identifier, the character offset range, and the document identifier derived from the source artifact descriptor, a combination thereof and the like. In some embodiments, the MentionID is generated by applying a keyed cryptographic function to the MentionID payload and the MentionID is stored in the redaction record.

In some embodiments, the privacy engine 120 is configured to link the MentionID to the EntityID and to the redaction record. In this manner, the EntityID identifies an underlying entity across repeated mentions and the MentionID identifies a specific occurrence location in a specific source artifact descriptor.

In some embodiments, the privacy engine 120 is configured to store a restricted mapping between EntityID values and sensitive values in a secure vault while maintaining the de-identified canonical text package in a matter repository 115. In some embodiments, a secure vault is a secure storage system configured to store restricted mapping records that associate de-identified identifiers with sensitive values, wherein the secure vault enforces access control policies, cryptographic protection, and audit logging for access to the restricted mapping records, a combination thereof and the like.

In some embodiments, the privacy engine 120 is configured to write, into the secure vault, a mapping record that includes the EntityID, the redaction type label, the sensitive span value, the matter identifier, the intake identifier, a version identifier, a combination thereof and the like.

In some embodiments, the privacy engine 120 is configured to enforce access control by associating the mapping record with an authorization policy that specifies permitted principals, permitted operations, and an audit logging requirement, a combination thereof and the like.

In some embodiments, the privacy engine 120 is configured to write, into the matter repository 115, the de-identified canonical text package together with the redaction records, a content hash computed across the de-identified canonical text package, a timestamp, a combination thereof and the like, thereby enabling reproducible downstream computation decoupled from the restricted mapping.

In some embodiments, the privacy engine 120 is configured to perform deterministic token hygiene within a given source artifact descriptor to preserve document-scoped referential consistency. In some embodiments, deterministic token hygiene includes detecting an internal inconsistency when two or more redaction records in the same document identifier reference the same EntityID and contain different surrogate tokens.

In some embodiments, deterministic token hygiene includes resolving the internal inconsistency by rewriting the differing surrogate tokens to a canonical surrogate token selected by a deterministic rule that selects the earliest allocated document-scoped index for the EntityID within the document identifier, a combination thereof and the like.

In some embodiments, the privacy engine 120 is configured to record each rewrite in a redaction update log that includes a prior surrogate token, an updated surrogate token, the associated redaction record identifiers, and the corresponding span identifiers, a combination thereof and the like. In this manner, the privacy engine 120 enforces deterministic consistency for the de-identified canonical text package.

In some embodiments, the privacy engine 120 is configured to generate aggregate reporting statistics derived from matter records while enforcing differential privacy guarantees to reduce re-identification risk. In some embodiments, the privacy engine 120 is configured to retrieve, from the matter repository 115, one or more aggregate query results computed over a cohort of matter records, wherein the aggregate query results include one or more of counts of redaction type labels, counts of document types, distributions of event type labels, aggregate timeline statistics, aggregate outcome frequencies, aggregate calibration and coverage metrics, a combination thereof and the like. In some embodiments, the privacy engine 120 is configured to apply a differential privacy mechanism to each aggregate query result by first bounding contribution of each matter record using clipping rules and sensitivity constraints, then adding Laplace noise parameterized by an epsilon value and, in some embodiments, a delta value specified in a privacy configuration record, thereby producing an (ε,δ)-differentially private aggregate result for output, a combination thereof and the like.

In some embodiments, applying the differential privacy mechanism includes adding Laplace noise having a scale parameter b=Δf/ϵ to an aggregate query result. In this example, Δf denotes a sensitivity value for the aggregate query under the applied clipping rules and contribution bounds, ϵ denotes an epsilon value specified in the privacy configuration record, and b denotes the Laplace noise scale used to generate the differentially private aggregate result.

In some embodiments, the privacy engine 120 is configured to maintain a privacy budget ledger that tracks privacy loss associated with releasing differentially private aggregate results. In some embodiments, the privacy budget ledger associates privacy budget consumption with one or more of a principal identifier, an authorization scope identifier, a query type identifier, a cohort identifier, and a time window identifier, a combination thereof and the like. In some embodiments, the privacy engine 120 is configured to enforce budget constraints by rejecting, delaying, or coarsening an aggregate query when a requested epsilon value would exceed an available privacy budget for a principal under an authorization policy, and recording budget consumption decisions in an audit log record, a combination thereof and the like.

In some embodiments, the privacy engine 120 is configured to compute a re-identification risk score for a query based on one or more of cohort size, uniqueness of requested attributes, repeated-query similarity, overlap of cohort definitions across requests, and whether a requested output is a near-exact refinement of a prior output, a combination thereof and the like. In some embodiments, when the re-identification risk score exceeds a threshold, the system enforces one or more controls including a minimum cohort size threshold, query throttling using a token bucket limiter keyed by principal identifier and query type identifier, increasing a noise scale by selecting a smaller epsilon value, returning a coarser-grained aggregate, and denying the query under the authorization policy, a combination thereof and the like.

In some embodiments, the privacy engine 120 is configured to store, in the matter record, a privacy governance repository a combination thereof and the like, a privacy enforcement record that includes the privacy configuration record identifier, the applied epsilon value and, in some embodiments, the delta value, a rate limit decision indicator, a cohort size value or cohort size bin, and an audit pointer to access logs for aggregate reporting and re-identification operations, a combination thereof and the like. In this manner, the system provides aggregate reporting while reducing re-identification risk through differential privacy and rate limiting controls enforced under the authorization policy.

In an embodiment, a structure engine 130 is configured to transform the de-identified canonical text package into a structured matter representation stored in the matter record.

In some embodiments, the structure engine 130 is configured to retrieve, for the source artifact descriptor, the ordered text spans together with the span identifiers and the redaction records.

In some embodiments, the structure engine 130 is configured to generate a document layout map by computing span-level layout features that include indentation depth, numbering-token patterns, capitalization patterns, punctuation density, line-break frequency, and proximity to detected caption fields, signature blocks, a combination thereof and the like.

In some embodiments, the structure engine 130 is configured to identify structural boundaries by applying deterministic boundary rules to the layout features. In some embodiments, the deterministic boundary rules include detecting headings using font-marker proxies embedded in the intermediate representation, detecting enumerated list items using numbering-token patterns, detecting citation blocks using citation-density thresholds computed across a sliding window of adjacent text spans, a combination thereof and the like.

In some embodiments, the structure engine 130 is configured to store, in the matter record, a hierarchy of structural units for the source artifact descriptor that includes a document unit, section units, subsection units, paragraph units, and clause units, a combination thereof and the like, wherein each structural unit includes a unit identifier, a parent unit identifier, a start span identifier, an end span identifier, a provenance pointer to the source artifact descriptor, a combination thereof and the like.

In an embodiment, the structure engine 130 is configured to generate clause units by decomposing paragraph units into legally meaningful subspans. The structure engine 130 is configured to tokenize each paragraph unit into sentences using punctuation-boundary rules and abbreviation guards derived from citation metadata. The structure engine 130 is configured to generate candidate clause boundaries using enumerator detection that evaluates tokens such as “(a)”, “(1)”, “i.”, “A.”, “First,”, and similar marker sequences captured by pattern rules.

In some embodiments, the structure engine 130 is configured to compute a clause cohesion score for each candidate boundary by evaluating semantic similarity between adjacent sentence embeddings derived from the de-identified canonical text package, evaluating syntactic continuity using part-of-speech tag transitions, and evaluating reference continuity using identifiers in the redaction records that correspond to the adjacent sentences, a combination thereof and the like.

In some embodiments, the structure engine 130 is configured to select a final set of clause boundaries by retaining candidate boundaries that satisfy a cohesion threshold while also satisfying a minimum clause length constraint measured in tokens.

In some embodiments, the structure engine 130 is configured to store each clause unit with a clause identifier, an ordered list of span identifiers, a token-offset map, and a list of referenced identifiers determined by scanning the clause unit for surrogate tokens and resolving each surrogate token to a corresponding redaction record that identifies an EntityID and a MentionID, a combination thereof and the like.

In some embodiments, the structure engine 130 is configured to label each structural unit with a legal role label and to store role-labeled segments in the matter record. The structure engine 130 is configured to compute, for each clause unit, a feature vector that includes cue-phrase indicators, tense patterns, citation presence indicators, statutory-reference indicators, motion-caption proximity indicators, and procedural-timeline position indicators derived from the matter timeline, a combination thereof and the like. The structure engine 130 is configured to apply a trained role classifier to the feature vector to generate a role label selected from a controlled vocabulary that includes FACT_SEGMENT, PROCEDURAL_HISTORY_SEGMENT, ISSUE_SEGMENT, ARGUMENT_SEGMENT, HOLDING_SEGMENT, REASONING_SEGMENT, and REMEDY_SEGMENT, a combination thereof and the like.

In some embodiments, the structure engine 130 is configured to store a role annotation record for each clause unit in the matter record. In some embodiments, the role annotation record includes the clause identifier, the role label, a confidence score, the supporting feature values used to compute the role label, and references to the span identifiers that contributed to the role label.

In some embodiments, the structure engine 130 is configured to extract issue statements and holding statements from the role-labeled segments by selecting one or more clause units as supporting text and generating, for each extracted statement, a normalized statement text stored in a corresponding semantic record in the matter record, a combination thereof and the like.

In some embodiments, the structure engine 130 identifies candidate issue clauses by selecting clause units labeled ISSUE_SEGMENT, ARGUMENT_SEGMENT, a combination thereof and the like, generates an issue candidate phrase set by extracting noun-phrase chunks and predicate frames from each selected clause unit. In some embodiments, the structure engine 130 is configured to normalize each issue candidate phrase by lemmatizing tokens, removing stop phrases, expanding abbreviations using a legal abbreviation dictionary, and replacing surrogate tokens with corresponding EntityID placeholders based on redaction records referenced by the clause unit, a combination thereof and the like. The structure engine 130 then deduplicates normalized issue candidates by computing pairwise embedding similarity across the normalized issue candidates and merging candidates that exceed a similarity threshold while also satisfying an EntityID overlap constraint computed from referenced EntityID placeholders, a combination thereof and the like. The structure engine 130 stores each resulting issue as an issue record that includes an issue identifier, a normalized issue text, a list of supporting clause identifiers, and a list of referenced citation records determined by intersecting citation span references with the supporting clause identifiers.

In an embodiment, the structure engine 130 is configured to extract holdings and to link each holding to one or more issues using explicit linkage operations stored in the matter record. The structure engine 130 identifies candidate holding clauses by selecting clause units labeled HOLDING_SEGMENT and REMEDY_SEGMENT, then extracts decision verbs and dispositive phrases using a dispositive-phrase lexicon that includes phrases such as “granted,” “denied,” “dismissed,” “affirmed,” and “reversed,” a combination thereof and the like. In some embodiments, the structure engine 130 is configured to generate, from the candidate holding clauses, a holding statement by extracting a dispositive predicate phrase and normalizing the clause text into a normalized holding text representation, a combination thereof and the like. The structure engine 130 computes a holding polarity value by mapping each dispositive phrase to a polarity label and by resolving negation scope using dependency-parse edges computed over the clause text. The structure engine 130 links a holding to an issue by computing an issue-holding compatibility score that includes shared EntityID overlap computed from EntityID placeholders referenced by the issue record and the holding clause unit, shared citation record overlap, temporal proximity within the matter timeline, and semantic similarity between the normalized issue text and the holding clause embedding, a combination thereof and the like. The structure engine 130 stores a holding record that includes a holding identifier, a normalized holding text, a polarity label, the supporting clause identifiers, and a set of issue linkage records that identify the linked issue identifiers together with the corresponding compatibility scores.

In some embodiments, the structure engine 130 is configured to store, in the matter record stored in the matter repository 115, the extracted issue statements and holding statements as normalized legal semantic records including one or more issue records and one or more holding records, a combination thereof and the like.

In some embodiments, the structure engine 130 is configured to extract citation treatment semantics and to store treatment-labeled citation relations in the matter record.

In some embodiments, the structure engine 130 is configured to evaluate each citation record together with a context window defined by a set of span identifiers surrounding the citation span reference, then identifies treatment cues by matching context-window phrases against a treatment lexicon that includes “distinguish,” “follow,” “decline,” “overrule,” “apply,” “criticize,” and similar cue terms, a combination thereof and the like.

In some embodiments, the structure engine 130 is configured to generate a treatment label by combining the lexicon matches with syntactic relations between the cue term and the cited authority reference determined using dependency parsing on the context window.

In some embodiments, the structure engine 130 is configured to store a citation treatment record. In some embodiments, the citation treatment record includes a cited authority identifier, a treatment label, a treatment confidence score, the supporting clause identifiers, and an attribution map that identifies the specific tokens and dependency edges that produced the treatment label.

In an embodiment, a graph construction engine 140 is configured to serialize the structural units, the role annotation records, the issue records, the holding records, the citation treatment records, a combination thereof and the like, into heterogeneous graph nodes, heterogeneous graph edges, and node attributes.

In some embodiments, the graph construction engine 140 is configured to generate a heterogeneous graph for the target legal matter based on the heterogeneous graph nodes, heterogeneous graph edges, node attributes, a combination thereof and the like.

In some embodiments, the graph construction engine 140 is configured to store the heterogeneous graph, heterogeneous graph nodes, heterogeneous graph edges, node attributes, a combination thereof and the like, in the matter record.

In some embodiments, the graph construction engine 140 is configured to retrieve, from the matter record, the structured matter representation including the structural units, the role annotation records, the issue records, the holding records, and the citation treatment records, together with the source artifact descriptors, the citation records, the matter timeline, and the redaction records that include EntityID and MentionID values, a combination thereof and the like.

In some embodiments, the graph construction engine 140 is configured to initialize a graph schema that defines a set of heterogeneous graph node types, a set of heterogeneous graph edge types, and a set of attribute fields for each heterogeneous graph node type and each edge type, then stores the graph schema in the matter repository 115 with a schema identifier, version identifier, a combination thereof and the like.

In some embodiments, the graph construction engine 140 is configured to generate graph nodes by serializing matter artifacts into typed node records.

In some embodiments, the graph construction engine 140 is configured to generate, for each source artifact descriptor, a DOCUMENT node that includes a document identifier derived from the document fingerprint, a retrieval timestamp, a file format identifier, a provenance pointer to a source endpoint identifier, a linkage to the matter identifier, a combination thereof and the like.

In some embodiments, the graph construction engine 140 is configured to generate, for each structural unit, a STRUCTURAL_UNIT node that includes a unit identifier, a unit type label, a start span identifier, an end span identifier, a provenance pointer to the source artifact descriptor, a combination thereof and the like.

In some embodiments, the graph construction engine 140 is configured to generate, for each issue record, an ISSUE node that includes an issue identifier, a normalized issue text, references to supporting clause identifiers, a combination thereof and the like.

In some embodiments, the graph construction engine 140 is configured to generate, for each holding record, a HOLDING node that includes a holding identifier, a normalized holding text, a polarity label, references to supporting clause identifiers, a combination thereof and the like.

In some embodiments, the graph construction engine 140 is configured to generate, for each citation record, an AUTHORITY node that includes a cited authority identifier, a canonical reporter label, a normalized pin cite representation, a citation type label, a combination thereof and the like.

In some embodiments, the graph construction engine 140 is configured to generate, for each redaction record, an ENTITY node keyed by EntityID and a MENTION node keyed by MentionID. In some embodiments, the ENTITY node includes a redaction type label, an entity usage summary attribute, a combination thereof and the like. In some embodiments, the MENTION node includes a span identifier, a character offset range, the document identifier, a combination thereof and the like.

In some embodiments, the graph construction engine 140 is configured to store, in the matter record, the DOCUMENT node that represents the source artifact descriptor and the document-unit STRUCTURAL_UNIT node that represents a parsed structure root for the same source artifact descriptor.

In some embodiments, the graph construction engine 140 is configured to generate a CONTAINS edge from the DOCUMENT node to the document-unit STRUCTURAL_UNIT node and generates PARENT_OF edges from the document-unit STRUCTURAL_UNIT node to descendant STRUCTURAL_UNIT nodes based on parent unit identifiers stored in the structured matter representation.

In some embodiments, the graph construction engine 140 assigns, on the CONTAINS edge, a containment order value computed from span identifier ordering and stores, on each PARENT_OF edge, a unit depth value computed from repeated traversal of parent unit identifiers until reaching the document-unit STRUCTURAL_UNIT node.

In some embodiments, the graph construction engine 140 is configured to generate additional graph edges by linking the typed node records using deterministic linkage operations. For example, the graph construction engine 140 generates a SUPPORTS edge from each ISSUE node to each STRUCTURAL_UNIT node that corresponds to a supporting clause identifier in the issue record. In another example, the graph construction engine 140 generates a SUPPORTS edge from each HOLDING node to each STRUCTURAL_UNIT node that corresponds to a supporting clause identifier in the holding record. In another example, the graph construction engine 140 generates a RESOLVES edge from a HOLDING node to an ISSUE node based on an issue linkage record stored with the holding record and stores, on the RESOLVES edge, a compatibility score value from the issue linkage record, a combination thereof and the like.

In some embodiments, the graph construction engine 140 is configured to generate a ROLE_LABEL node for each controlled vocabulary label and to generate a HAS_ROLE edge that links a role-labeled STRUCTURAL_UNIT node to a corresponding ROLE_LABEL node. In some embodiments, the graph construction engine 140 assigns, as attributes on the HAS_ROLE edge, a confidence score and supporting feature values from a corresponding role annotation record, a combination thereof and the like.

In some embodiments, the graph construction engine 140 is configured to encode citation relationships as typed edges that preserve citation provenance and treatment semantics.

In some embodiments, the graph construction engine 140 is configured to identify, for a given citation record, a citing STRUCTURAL_UNIT node by resolving a citation span reference to one or more span identifiers and mapping the span identifiers to a clause identifier that is referenced by a STRUCTURAL_UNIT node.

In some embodiments, the graph construction engine 140 is configured to generate a CITES edge from the citing STRUCTURAL_UNIT node to the corresponding AUTHORITY node and assigns, on the CITES edge, the citation span reference, the citation type label, and a provenance pointer to the source artifact descriptor.

In some embodiments, the graph construction engine 140 is configured to generate a TREATMENT edge from the citing STRUCTURAL_UNIT node to the AUTHORITY node and assigns, on the TREATMENT edge, a treatment label, a treatment confidence score, and an attribution map from the citation treatment record. In some embodiments, the graph construction engine 140 copies treatment label fields from the citation treatment record into the TREATMENT edge attributes.

In some embodiments, the graph construction engine 140 is configured to assign treatment semantics as a TREATMENT edge parallel to a CITES edge so that base citation provenance is associated on the CITES edge and treatment attribution is associated on the TREATMENT edge.

In some embodiments, the graph construction engine 140 is configured to encode temporal information using timestamp attributes and timeline edges derived from the matter timeline.

In some embodiments, the graph construction engine 140 is configured to generate a PRECEDES edge from a first EVENT node to a second EVENT node when a first normalized event timestamp of the first EVENT node precedes a second normalized event timestamp of the second EVENT node. In some embodiments, the graph construction engine 140 is configured to generate a PRECEDES edge from the second EVENT node to a third EVENT node when the second normalized event timestamp precedes a third normalized event timestamp

In some embodiments, the graph construction engine 140 is configured to generate an EVENT node for each event in the matter timeline, wherein the EVENT node includes an event identifier, an event type label, and a normalized event timestamp determined from extracted filing dates and docket sequence identifiers.

In some embodiments, the graph construction engine 140 is configured to generate a REFERENCES_EVENT edge from each DOCUMENT node to each EVENT node based on linkages stored in the matter timeline and generates a PRECEDES edge between EVENT nodes based on an ordered event sequence stored in the matter timeline.

In some embodiments, the graph construction engine 140 is configured to assign, as edge attributes, a time delta value computed from normalized event timestamps and a sequence delta value computed from docket sequence identifiers, thereby enabling downstream traversal that respects time ordering.

In some embodiments, the graph construction engine 140 is configured to generate an EVENT node for each event in the matter timeline, wherein a first EVENT node includes a first normalized event timestamp and a second EVENT node includes a second normalized event timestamp determined from extracted filing dates and docket sequence identifiers. In some embodiments, the graph construction engine is configured to generate a PRECEDES edge from the first EVENT node to the second EVENT node when the first normalized event timestamp precedes the second normalized event timestamp. In some embodiments, the graph construction engine assigns, as edge attributes on the PRECEDES edge, a time delta value computed as a difference between the second normalized event timestamp and the first normalized event timestamp, and a sequence delta value computed as a difference between a second docket sequence identifier and a first docket sequence identifier.

In some embodiments, the graph construction engine 140 is configured to link de-identified entity representations into the heterogeneous graph while preserving document-scoped surrogate tokens in the de-identified canonical text package.

In some embodiments, the graph construction engine 140 is configured to generate a MENTIONS edge from each STRUCTURAL_UNIT node to each MENTION node referenced by the clause unit and assigns, on the MENTIONS edge, a surrogate token extracted from the de-identified canonical text package together with a pointer to a corresponding redaction record.

In some embodiments, the graph construction engine 140 is configured to generate a REFERS_TO edge from each MENTION node to a corresponding ENTITY node keyed by EntityID, thereby enabling cross-document linkage through the ENTITY node while maintaining document-scoped surrogate tokens in the de-identified canonical text package.

In some embodiments, the graph construction engine 140 is configured to update the entity usage summary attribute on the ENTITY node by aggregating counts of linked MENTION nodes across document identifiers and redaction type labels, a combination thereof and the like.

In some embodiments, the graph construction engine 140 is configured to validate, index, version, a combination thereof and the like, the heterogeneous graph in the matter record.

In some embodiments, the graph construction engine 140 is configured to validate node records and edge records against the graph schema by checking required fields, checking type constraints, checking that each edge endpoint references an existing node identifier, and checking that each provenance pointer references an existing source artifact descriptor, a combination thereof and the like.

In some embodiments, the graph construction engine 140 is configured to generate one or more graph indexes that include a node-type index, an edge-type index, a document identifier index, an EntityID index, and a normalized event timestamp index, a combination thereof and the like.

In some embodiments, the graph construction engine 140 is configured to persist the heterogeneous graph in a compressed sparse row (CSR) adjacency representation that is partitioned by edge type and, in some embodiments, by node type. In some embodiments, the graph construction engine 140 assigns contiguous identifier ranges to node identifiers grouped by heterogeneous graph node type and maintains a node-type partition table that maps each node type label to an identifier range and a base offset, a combination thereof and the like. In some embodiments, for each heterogeneous graph edge type label, the graph construction engine 140 generates a CSR adjacency structure comprising (i) a row pointer array indexed by source node identifier offsets, (ii) a column index array storing target node identifier offsets, and (iii) an edge identifier array aligned with the column index array to reference edge attribute records, a combination thereof and the like. In some embodiments, the graph construction engine 140 further generates a compressed sparse column (CSC) adjacency structure for reverse traversal by swapping source and target roles, thereby enabling efficient inbound-edge queries for downstream traversal and learning, a combination thereof and the like.

In some embodiments, the graph construction engine 140 is configured to store, in the matter record, a graph snapshot that includes the node records, the edge records, the graph schema identifier, and a graph content hash computed across a canonical serialization of the node records and the edge records, together with a timestamp and the intake identifier.

In some embodiments, the graph construction engine 140 is configured to compute edge attributes and node attributes in type-partitioned attribute tables aligned to the CSR adjacency representation. In some embodiments, for a given edge type label, numeric edge attributes and categorical edge attributes are stored as columnar arrays keyed by edge identifier position within the CSR edge identifier array, thereby enabling vectorized retrieval of attribute values for a batch of edges of a single type label, a combination thereof and the like. In some embodiments, the graph construction engine 140 stores, for each edge type label, an edge-type header record that identifies the CSR file segments or byte ranges for the row pointer array, the column index array, the edge identifier array, and the corresponding attribute columns, together with a graph snapshot identifier and a graph content hash, a combination thereof and the like. In some embodiments, the graph construction engine 140 is configured to persist the CSR adjacency representation using one or more of memory-mapped files, chunked binary segments, and log-structured append storage to support efficient partial updates across graph snapshots while preserving reproducibility, a combination thereof and the like.

In some embodiments, the graph construction engine 140 is configured to maintain an optional property-graph-compatible persistent representation of the heterogeneous graph to support external query engines. In some embodiments, the graph construction engine 140 maps each heterogeneous graph node type label to a property-graph node label and maps each heterogeneous graph edge type label to a property-graph relationship type, and stores node attributes and edge attributes as key-value properties, a combination thereof and the like. In some embodiments, the graph construction engine 140 is configured to generate, for a given graph snapshot identifier, a property-graph export package that includes node records and relationship records encoded in a schema compatible with a Neo4j-compatible property-graph model, wherein the export package preserves node identifiers, edge identifiers, and provenance pointers so that traversals executed in the property graph correspond to traversals over the CSR adjacency representation by construction, a combination thereof and the like.

In an embodiment, an embedding engine 150 is configured to generate vector representations for heterogeneous graph elements stored in the matter record.

In some embodiments, the embedding engine 150 is configured to retrieve a graph snapshot from the matter record including node records, edge records, node attributes, edge attributes, and provenance pointers that link each graph element to one or more span identifiers in the de-identified canonical text package, a combination thereof and the like.

In some embodiments, the embedding engine 150 is configured to select one or more embedding models based on graph element type and attribute availability.

In some embodiments, the embedding engine 150 is configured to store, in the matter record, an embedding configuration record that includes a model identifier, a model version identifier, an input field specification, a tokenization specification, an output dimension specification, a normalization specification for embedding vectors, a combination thereof and the like.

In some embodiments, the embedding engine is configured to select a bidirectional transformer encoder architecture as a text embedding model, wherein the transformer encoder includes a plurality of self-attention layers and is pre-trained on a general-purpose corpus, then adapted using a legal-domain corpus that includes judicial opinions, statutory texts, and regulatory materials.

In some embodiments, adapting the transformer encoder includes performing masked language modeling on the legal-domain corpus to tune vocabulary representations and contextual usage of legal terms and procedural phrases, and performing one or more span-level prediction tasks using labeled legal datasets to improve extraction of claim elements, issue statements, holding statements, and supporting rationales.

In some embodiments, the embedding engine is configured to generate contextual embeddings for document sections, clause units, and fact spans by encoding de-identified text spans in token windows subject to a maximum token length constraint, wherein long spans are encoded using a sliding-window segmentation strategy and the embedding engine generates a fixed-length embedding vector from a final hidden layer representation using a pooling operation that includes a designated classification token pooling operation and an aggregated token pooling operation.

In some embodiments, the embedding engine is configured to project a contextual embedding vector into a lower-dimensional node feature vector for use by downstream graph learning, wherein the embedding engine applies a learned linear projection to map a higher-dimensional contextual embedding space into a lower-dimensional node-feature space that reduces memory footprint and accelerates relation-aware message passing.

In some embodiments, the embedding engine 150 is configured to generate text-derived node embedding vectors for the node records that include textual content.

In some embodiments, the embedding engine 150 is configured to construct a node text payload for the node record by retrieving, from the de-identified canonical text package, a set of text spans referenced by the node record and concatenating the text spans in a deterministic order determined by span identifier ordering. In some embodiments, constructing the node text payload includes applies preprocessing to the node text payload by normalizing whitespace, normalizing numbering tokens, and normalizing citation strings into a canonical citation format based on citation records, a combination thereof and the like.

In some embodiments, the embedding engine 150 is configured to tokenize the node text payload using a tokenizer associated with the embedding model and generates a sequence of token identifiers together with segment boundaries that identify sentence splits and clause splits derived from clause units in the structured matter representation.

In some embodiments, the embedding engine 150 is configured to apply the embedding model to the sequence of token identifiers to generate a contextual token embedding matrix and derives a fixed-length node embedding vector by applying an aggregation operation that includes attention pooling across token embeddings weighted using role labels from role annotation records while excluding padding tokens from the aggregation, a combination thereof and the like.

In some embodiments, the embedding engine 150 is configured to store the node embedding vector in an embedding store indexed by a node identifier, an embedding configuration record identifier, and a graph snapshot identifier.

In some embodiments, the embedding engine 150 is configured to generate node embedding vectors for STRUCTURAL_UNIT nodes using role-aware segmentation and clause-level pooling.

In some embodiments, the embedding engine 150 is configured to retrieve the clause units associated with a STRUCTURAL_UNIT node by resolving a unit identifier to clause identifiers and span identifiers stored in the structured matter representation. In some embodiments, the embedding engine 150 is further configured to generate a node text payload into clause segments based on clause boundaries and generates clause embeddings by applying the embedding model to each clause segment and aggregating token embeddings within each clause segment using attention pooling weighted by a role label confidence score stored in a role annotation record for that clause unit. In some embodiments, the embedding engine 150 is configured to generate a STRUCTURAL_UNIT node embedding vector by concatenating a fixed number of clause embeddings selected using a deterministic selection rule that prioritizes clause segments with higher role label confidence scores and higher citation density values computed from CITES edges incident to the clause segments, then applies a projection operation that multiplies the concatenated vector by a learned weight matrix and adds a learned bias vector to map the concatenated vector to a fixed-length representation stored as the STRUCTURAL_UNIT node embedding vector.

In some embodiments, the embedding engine 150 is configured to generate node embedding vectors for AUTHORITY nodes and to incorporate citation metadata into the node embedding vectors.

In some embodiments, the embedding engine 150 is configured to construct an authority text payload by retrieving normalized citation strings, canonical reporter labels, normalized pin cite representations, and authority title text when available through source artifact descriptors, a combination thereof and the like.

In some embodiments, the embedding engine 150 encodes the authority text payload using the embedding model to generate an authority text embedding vector and constructs a citation metadata feature vector that includes a citation type encoding, a jurisdiction encoding, and a temporal feature encoding derived from a publication year value when available, a combination thereof and the like.

In some embodiments, the embedding engine 150 is configured to concatenate the authority text embedding vector and the citation metadata feature vector and applies a projection operation that multiplies the concatenated vector by a learned weight matrix and adds a learned bias vector to generate a fixed-length AUTHORITY node embedding vector stored in the embedding store.

In some embodiments, the embedding engine 150 is configured to generate node embedding vectors for ENTITY nodes and MENTION nodes while preserving de-identification.

In some embodiments, the embedding engine 150 is configured to construct an ENTITY feature payload that includes a redaction type label encoding and an entity usage summary attribute encoding stored on the ENTITY node, a combination thereof and the like.

In some embodiments, the embedding engine 150 is configured to construct an ENTITY context vector by selecting a set of neighboring STRUCTURAL_UNIT nodes that connect to the ENTITY node through REFERS_TO edges, and MENTIONS edges within a bounded hop distance and retrieving corresponding STRUCTURAL_UNIT node embedding vectors from the embedding store.

In some embodiments, the embedding engine 150 is configured to weight each neighboring STRUCTURAL_UNIT node embedding vector using a weighting function that assigns weights based on an inverse document frequency value computed from counts of MENTION nodes linked to the ENTITY node across document identifiers and sums the weighted STRUCTURAL_UNIT node embedding vectors to produce the ENTITY context vector.

In some embodiments, the embedding engine 150 is configured to concatenate the ENTITY context vector with the ENTITY feature payload and applies a projection operation to generate the ENTITY node embedding vector stored in the embedding store.

In some embodiments, the embedding engine 150 is configured to generate a MENTION node embedding vector using a parent context representation and position features.

In some embodiments, the embedding engine 150 is configured to identify a parent STRUCTURAL_UNIT node that links to a MENTION node through a MENTIONS edge and retrieves a parent STRUCTURAL_UNIT node embedding vector.

In some embodiments, the embedding engine 150 is configured to compute a span-position feature vector from the character offset range and span identifier ordering within a document identifier and computes an edge-local feature vector that encodes a surrogate token shape derived from the surrogate token stored on the MENTIONS edge, a combination thereof and the like.

In some embodiments, the embedding engine 150 is configured to concatenate the parent STRUCTURAL_UNIT node embedding vector, the span-position feature vector, and the edge-local feature vector and applies a projection operation to generate a fixed-length MENTION node embedding vector stored in the embedding store.

In some embodiments, the embedding engine 150 is configured to generate edge embedding vectors for heterogeneous graph edges based on edge attributes and edge type encodings.

In some embodiments, the embedding engine 150 is configured to construct an edge input feature vector for a given edge record by encoding an edge type label using a learned edge-type embedding table, extracting numeric edge attributes from the edge record, and computing topology features from graph connectivity that include source node degree, target node degree, and shortest-path distance to anchor nodes that include ISSUE nodes and HOLDING nodes, a combination thereof and the like. For citation-related edges, the embedding engine 150 is configured to augment the edge input feature vector using treatment semantics by encoding a treatment label, a treatment confidence score, and selected attribution-map features that include cue-token position indicators and dependency-edge type indicators, a combination thereof and the like. The embedding engine 150 is configured to apply a projection operation that multiplies the edge input feature vector by a learned weight matrix and adds a learned bias vector to generate a fixed-length edge embedding vector stored in the embedding store indexed by an edge identifier and the embedding configuration record identifier.

In some embodiments, the embedding engine 150 is configured to validate, version, and store embedding artifacts for reproducible downstream learning.

In some embodiments, the embedding engine 150 is configured to validate each node embedding vector and each edge embedding vector by checking dimension constraints specified by the embedding configuration record and by checking numeric range constraints defined for the embedding store, a combination thereof and the like.

In some embodiments, the embedding engine 150 is configured to store, in the matter record, an embedding snapshot that includes node embedding vectors for a set of node identifiers, edge embedding vectors for a set of edge identifiers, the embedding configuration record identifier, and an embedding content hash computed across a canonical serialization of the embedding vectors and corresponding identifiers. In some embodiments, the embedding engine 150 is configured to store the embedding snapshot in the matter repository 115 together with a timestamp, the intake identifier, and the graph snapshot identifier.

In some embodiments, a graph learning engine 160 is configured to generate learned graph representations from the heterogeneous graph and an embedding snapshot stored in the matter record.

In some embodiments, the graph learning engine 160 is configured to retrieve a graph snapshot including node records, edge records, node attributes, and edge attributes, together with an embedding snapshot that includes node embedding vectors and edge embedding vectors indexed by node identifiers and edge identifiers, a combination thereof and the like.

In some embodiments, the graph learning engine 160 is configured to initialize a relation-aware graph neural network model using a model configuration record that specifies a set of message-passing layers, a set of relation types that correspond to edge type labels in the graph schema, an attention mechanism specification, and an output representation dimension, a combination thereof and the like.

In some embodiments, the graph learning engine 160 is configured to store, in the matter repository 115, the model configuration record with a model version identifier and associates the model version identifier with the graph snapshot identifier and the embedding snapshot identifier.

In some embodiments, the graph learning engine 160 is configured to initialize current node representations using node embedding vectors and to iteratively update the current node representations using relation-aware message passing. In some embodiments, the graph learning engine 160 is configured to initialize, for each node identifier in the graph snapshot, a current node representation by copying a corresponding node embedding vector from the embedding snapshot into a node representation table indexed by the node identifier and a message-passing layer index. For example, for a given message-passing layer, the graph learning engine 160 selects an edge batch that includes a set of edge records and corresponding source node identifiers and target node identifiers and groups the edge records by edge type label. In another example, for each group corresponding to an edge type label, the graph learning engine 160 is configured to apply a relation transform by multiplying a current source node representation by a relation-specific weight matrix and adding a relation-specific bias vector, thereby producing a relation-transformed source representation for that edge type label.

In some embodiments, the graph learning engine 160 is configured to compute attention weights for edges using current node representations and edge embedding vectors.

In some embodiments, for each edge record, the graph learning engine 160 is configured to retrieve an edge embedding vector for the edge record and constructs an attention input vector by concatenating a relation-transformed source representation, a current target node representation, and the edge embedding vector, a combination thereof and the like.

In some embodiments, the graph learning engine 160 is configured to apply an attention scoring network to the attention input vector to generate a scalar edge score. In some embodiments, the graph learning engine 160 is configured to normalize scalar edge scores across inbound edges for each target node identifier by computing a softmax normalization over the scalar edge scores for the inbound edges and stores normalized attention weights for the inbound edges.

In some embodiments, the graph learning engine 160 is configured to aggregate relation-transformed messages and to compute updated node representations for each message-passing layer. For a target node identifier, the graph learning engine 160 is configured to compute an aggregated message by summing relation-transformed source representations multiplied by corresponding normalized attention weights across inbound edges for the target node identifier. The graph learning engine 160 is configured to concatenate the aggregated message with a current target node representation and applies an update network that includes a linear projection, a non-linear activation, and a residual connection that adds a projected aggregated message to the current target node representation, thereby producing an updated target node representation for the message-passing layer. In some embodiments, the graph learning engine 160 is configured to write the updated target node representation into the node representation table as a current node representation for a subsequent message-passing layer and repeats the message passing and update operations across a plurality of message-passing layers to generate final node representations.

In some embodiments, the graph learning engine 160 is configured to generate pooled representations across a structural hierarchy defined by CONTAINS edges and PARENT_OF edges. The graph learning engine 160 is configured to identify, for each DOCUMENT node, a document-unit STRUCTURAL_UNIT node linked by a CONTAINS edge and identifies descendant STRUCTURAL_UNIT nodes by traversing PARENT_OF edges from the document-unit STRUCTURAL_UNIT node.

In some embodiments, the graph learning engine 160 is configured to compute a paragraph-level pooled representation by selecting clause-level STRUCTURAL_UNIT nodes that share a parent paragraph unit identifier and aggregating corresponding final node representations using attention pooling with attention weights derived from role label confidence scores stored in role annotation records referenced by HAS_ROLE edges.

In some embodiments, the graph learning engine 160 is configured to compute a section-level pooled representation by selecting paragraph-level pooled representations that share a parent section unit identifier and aggregating the paragraph-level pooled representations using attention pooling with attention weights derived from citation density values computed from counts of CITES edges incident to the paragraph-level STRUCTURAL_UNIT nodes.

In some embodiments, the graph learning engine 160 is configured to compute a document-level pooled representation by aggregating section-level pooled representations for STRUCTURAL_UNIT nodes under the document-unit STRUCTURAL_UNIT node using attention pooling with attention weights derived from event recency values computed from normalized event timestamps stored in EVENT nodes linked to the DOCUMENT node through REFERENCES_EVENT edges, a combination thereof and the like.

In some embodiments, the graph learning engine 160 is configured to store the clause-level pooled representations, the paragraph-level pooled representations, the section-level pooled representations, the document-level pooled representations, a combination thereof and the like, in the matter record indexed by unit identifiers and document identifiers.

In some embodiments, the graph learning engine 160 is configured to generate a matter-level representation for the target legal matter using document-level pooled representations and matter timeline information.

In some embodiments, the graph learning engine 160 is configured to retrieve document-level pooled representations for DOCUMENT nodes linked to EVENT nodes through REFERENCES_EVENT edges and orders the document-level pooled representations based on normalized event timestamps associated with the EVENT nodes.

In some embodiments, the graph learning engine 160 is configured to compute a temporal weighting value for each document-level pooled representation by applying a time-decay weighting function to the normalized event timestamp associated with the document-level pooled representation, wherein the time-decay weighting function produces larger weights for more recent normalized event timestamps.

In some embodiments, the graph learning engine 160 is configured to compute the matter-level representation by summing document-level pooled representations multiplied by corresponding temporal weighting values and stores the matter-level representation in the matter record indexed by the matter identifier and the graph snapshot identifier.

In some embodiments, the graph learning engine 160 is configured to train the relation-aware graph neural network model using auxiliary objectives that preserve heterogeneous graph structure.

In some embodiments, the graph learning engine 160 is configured to define an edge reconstruction objective by selecting a set of positive edges from the edge records and generating a set of negative edge samples by sampling node identifier pairs that lack an edge record of a corresponding edge type label. In some embodiments, the graph learning engine 160 is configured to compute, for each sampled edge, an edge score by applying an edge scoring network to a concatenation of final node representations for endpoints of the sampled edge together with an edge embedding vector for the sampled edge and compares the edge score to a target label that identifies the sampled edge as a positive edge or a negative edge, thereby producing an edge reconstruction loss value.

In some embodiments, the graph learning engine 160 defines a treatment prediction objective by selecting TREATMENT edges and predicting a treatment label using a concatenation of a final node representation for a citing STRUCTURAL_UNIT node, a final node representation for an AUTHORITY node, and an edge embedding vector for the TREATMENT edge, then computing a classification loss value based on the predicted treatment label and a treatment label stored on the TREATMENT edge.

In some embodiments, the graph learning engine 160 is configured to combine an auxiliary objective loss values with a primary objective loss value associated with a downstream prediction task using a weighted sum to generate a training loss value and updates model parameters by applying gradient-based optimization using the training loss value.

In some embodiments, the graph learning engine 160 is configured to store learned representations and model artifacts in the matter repository 115. In some embodiments, the graph learning engine 160 is configured to store final node representations for a set of node identifiers, pooled representations for a set of unit identifiers and document identifiers, and the matter-level representation for the matter identifier in a learned representation store associated with the matter repository 115. In some embodiments, the graph learning engine 160 is configured to store a learned representation snapshot that includes identifiers of stored representations, a model version identifier, a graph snapshot identifier, an embedding snapshot identifier, and a representation content hash computed across a canonical serialization of stored representations and corresponding identifiers. In some embodiments, the graph learning engine 160 is configured to store the learned representation snapshot together with a timestamp and the intake identifier, thereby enabling downstream prediction stages to retrieve a selected learned representation snapshot corresponding to a selected graph snapshot and a selected embedding snapshot stored in the matter record.

In some embodiments, an entity tracking engine 165 is configured to perform cross-document identity inference for de-identified entities represented in the heterogeneous graph and to store inferred entity linkage results in the matter record.

In some embodiments, the entity tracking engine 165 is configured to retrieve, from the matter record, a graph snapshot that includes ENTITY nodes keyed by EntityID, MENTION nodes keyed by MentionID, REFERS_TO edges linking MENTION nodes to ENTITY nodes, MENTIONS edges linking STRUCTURAL_UNIT nodes to MENTION nodes, and DOCUMENT nodes linked to source artifact descriptors, a combination thereof and the like. In some embodiments, the entity tracking engine 165 is further configured to retrieve redaction records that include redaction type labels, document identifiers, span identifiers, and provenance pointers, together with structured matter representation fields that include party role descriptors, counsel identifiers, caption fields, and docket-level metadata extracted by the intake engine, a combination thereof and the like. In some embodiments, the entity tracking is configured to store an entity tracking configuration record that identifies a set of candidate generation rules, a set of legality-aware constraints, and a probabilistic inference specification for generating posterior linkage values.

In some embodiments, the entity tracking engine 165 is configured to generate candidate cross-document link hypotheses among ENTITY nodes using deterministic blocking operations that reduce a search space. The entity tracking engine 165 is configured to generate one or more blocking keys for an ENTITY node using redaction type labels, tribunal identifiers, party role descriptors, normalized counsel identifiers, normalized caption role labels, and co-occurrence signatures derived from neighboring ISSUE nodes and HOLDING nodes connected through STRUCTURAL_UNIT nodes, a combination thereof and the like.

In some embodiments, the entity tracking engine 165 is configured to partition the ENTITY nodes into candidate buckets using the blocking keys and generates candidate pairs by enumerating pairs of ENTITY nodes within the same candidate bucket.

In some embodiments, the entity tracking engine 165 is configured to filter candidate pairs by applying compatibility rules that reject candidate pairs that violate redaction type compatibility, jurisdiction compatibility, and temporal compatibility computed from normalized event timestamps associated with DOCUMENT nodes that reference the ENTITY nodes through MENTION nodes, a combination thereof and the like. In some embodiments, the entity tracking is configured to store, for each surviving candidate pair, a link hypothesis record that includes a pair identifier, identifiers of the candidate ENTITY nodes, and a set of features computed for the candidate pair.

In some embodiments, the entity tracking engine 165 is configured to compute a candidate pair feature set for each link hypothesis record using graph-derived, text-derived, and metadata-derived signals. In some embodiments, the candidate pair feature set includes one or more of a name-shape feature set, a role-consistency feature set, a context-similarity feature set, a citation-neighborhood feature set, a temporal-compatibility feature set, a combination thereof and the like.

In some embodiments, the entity tracking is configured to compute the name-shape feature set by retrieving, from the secure vault under an authorization policy, a hashed name signature for each EntityID and comparing hashed name signatures using a similarity function that includes n-gram overlap computed on hashed token sequences and edit-distance values computed on hashed character trigrams, a combination thereof and the like.

In some embodiments, the entity tracking is configured to compute the role-consistency feature set by extracting party role descriptors and counsel identifiers for MENTION nodes that refer to each ENTITY node and computing a role consistency score by counting matching role labels and matching counsel identifiers across documents, a combination thereof and the like.

In some embodiments, the entity tracking is configured to compute the context-similarity feature set by selecting neighboring STRUCTURAL_UNIT nodes that mention the ENTITY nodes and retrieving corresponding learned representations from the learned representation snapshot, then computing a cosine similarity value between aggregated context vectors for the candidate ENTITY nodes.

In some embodiments, the entity tracking is configured to compute the citation-neighborhood feature set by counting shared AUTHORITY nodes connected through CITES edges and TREATMENT edges incident to STRUCTURAL_UNIT nodes that mention the candidate ENTITY nodes, then generating a normalized overlap score.

In some embodiments, the entity tracking engine 165 is configured to store the candidate pair feature set in the link hypothesis record for the candidate pair.

In some embodiments, the entity tracking engine 165 is configured to construct an entity linkage graph and to apply legality-aware constraints to the entity linkage graph. The entity tracking engine 165 represents each ENTITY node as a vertex and represents each candidate pair as a candidate linkage edge with an associated feature set.

In some embodiments, the entity tracking engine 165 is configured to apply hard constraints that eliminate candidate linkage edges that violate mutually exclusive attributes derived from the matter record, including constraints that prevent linking entities with conflicting party role descriptors within the same caption field, constraints that prevent linking entities with conflicting counsel identifiers associated with the same docket event, and constraints that prevent linking entities whose redaction type labels differ, a combination thereof and the like.

In some embodiments, the entity tracking engine 165 is configured to apply soft constraints by assigning penalty values to candidate linkage edges when a feature value indicates incompatibility, including penalty values based on large temporal gaps in normalized event timestamps, low context similarity values, and low citation-neighborhood overlap scores, a combination thereof and the like.

In some embodiments, the entity tracking engine 165 is configured to store, in the matter repository 115, a constrained entity linkage graph that includes surviving candidate linkage edges and associated constraint-derived penalty values.

In some embodiments, the entity tracking engine 165 is configured to perform probabilistic inference over the constrained entity linkage graph to generate posterior linkage values for candidate linkage edges.

In some embodiments, the entity tracking engine 165 is configured to transform each candidate linkage edge into a probabilistic edge weight by applying a scoring model to the feature set, wherein the scoring model includes a calibrated logistic scoring function that maps the feature set to a linkage probability value. In some embodiments, the entity tracking engine 165 is configured to iteratively refine probabilistic edge weights using a graph-flow inference procedure that enforces global consistency across candidate linkages by routing linkage mass through the constrained entity linkage graph subject to constraints, wherein the graph-flow inference procedure includes repeated updates that conserve total linkage mass for each ENTITY node and reduce linkage mass along constrained edges. In some embodiments, the entity tracking engine 165 is configured to terminate the repeated updates when a convergence criterion is satisfied based on changes in probabilistic edge weights across iterations and stores posterior linkage values for the candidate linkage edges.

In some embodiments, the probabilistic edge weight assigned to a candidate linkage edge is a compatibility value between the candidate ENTITY nodes. For example, for a candidate linkage edge between a first ENTITY node having EntityID i and a second ENTITY node having EntityID j, the entity tracking engine 165 computes a compatibility value cᵢⱼ by applying the scoring model to the candidate pair feature set fᵢⱼ, wherein cᵢⱼ=σ(w^{T}fᵢⱼ). In this example, fᵢⱼ denotes the candidate pair feature set stored in the link hypothesis record for the candidate pair, w denotes a parameter vector of the scoring model, σ(⋅) denotes a logistic function, and cᵢⱼ denotes the linkage probability value used as the probabilistic edge weight for the candidate linkage edge.

In some embodiments, the entity tracking engine 165 is configured to use the probabilistic edge weights cᵢⱼ in the probabilistic inference procedure to generate posterior linkage values for candidate linkage edges and to generate identity clusters based on the posterior linkage values.

In some embodiments, the entity tracking engine 165 is configured to generate one or more identity clusters based on posterior linkage values and to store cluster identifiers in the matter record.

In some embodiments, the entity tracking engine 165 is configured to select a set of candidate linkage edges that satisfy a posterior threshold and generates connected components in the entity linkage graph using the selected candidate linkage edges. The entity tracking engine 165 is configured to assign an identity cluster identifier to each connected component and stores, for each ENTITY node, a cluster membership record that includes the EntityID, the identity cluster identifier, and a cluster confidence value computed from posterior linkage values of edges within the connected component, a combination thereof and the like.

In some embodiments, the entity tracking engine 165 is configured to generate a tracking EntityGroupID for each identity cluster by applying a keyed cryptographic function to a canonical serialization of the EntityID values in the identity cluster, then stores the tracking EntityGroupID as an attribute on an ENTITY_GROUP node in the heterogeneous graph and links each ENTITY node in the identity cluster to the ENTITY_GROUP node using a MEMBER_OF edge.

In some embodiments, the entity tracking engine 165 is configured to update downstream graph attributes using entity tracking outputs while preserving de-identified representations. The entity tracking engine 165 is configured to update each ENTITY node with an inferred group identifier that corresponds to a tracking EntityGroupID and stores, for each REFERS_TO edge, an inferred linkage confidence value associated with the identity cluster of the referenced ENTITY node, a combination thereof and the like.

In some embodiments, the entity tracking engine 165 is configured to store an entity tracking snapshot in the matter record. In some embodiments, the entity tracking snapshot includes link hypothesis records, posterior linkage values, identity cluster identifiers, and a snapshot content hash computed across a canonical serialization of the entity tracking outputs, together with a timestamp, the intake identifier, the graph snapshot identifier, a combination thereof and the like.

In an embodiment, a prediction engine 170 is configured to generate a model output for a target legal matter using learned representations stored in the matter record.

In some embodiments, the prediction engine 170 is configured to retrieve, from the matter record, a learned representation snapshot that includes final node representations, pooled representations, and a matter-level representation generated by the graph learning engine 160, together with an entity tracking snapshot that includes tracking EntityGroupID values and cluster membership records generated by the entity tracking engine 165, a combination thereof and the like. The prediction engine 170 is further configured to retrieve a prediction configuration record that specifies a target event type, a prediction target label space, a task definition, and an evaluation metric definition, a combination thereof and the like.

In some embodiments, the prediction engine 170 is configured to initialize a predictive model using a model identifier and a model version identifier in the prediction configuration record and associates the predictive model with the learned representation snapshot identifier and the graph snapshot identifier.

In some embodiments, the prediction engine 170 is configured to construct a prediction feature tensor by selecting and transforming learned representations and graph-derived attributes associated with the target event type.

The prediction engine 170 is configured to identify a target scope for prediction by selecting one or more target nodes in the heterogeneous graph based on the target event type, wherein the target nodes include a HOLDING node, an ISSUE node, a DOCUMENT node, an EVENT node, and a STRUCTURAL_UNIT node, a combination thereof and the like. In some embodiments, the prediction engine 170 is configured to retrieve, for the target nodes, corresponding final node representations and pooled representations and constructs a representation set that includes a matter-level representation and a target-scope representation derived from the selected target nodes. In some embodiments, the prediction engine 170 is configured to generate graph-derived numeric features by computing degree statistics for selected node types, computing citation neighborhood statistics that include counts of CITES edges and TREATMENT edges incident to selected STRUCTURAL_UNIT nodes, computing temporal statistics from PRECEDES edges and normalized event timestamps, and computing entity group statistics from tracking EntityGroupID membership counts, a combination thereof and the like. In some embodiments, the prediction engine 170 is configured to concatenate the matter-level representation, the target-scope representation, and the graph-derived numeric features into the prediction feature tensor.

In some embodiments, the prediction engine 170 is configured to store the prediction feature tensor in association with the prediction configuration record identifier.

In some embodiments, the prediction engine 170 is configured to generate a model output by applying the predictive model to the prediction feature tensor.

In some embodiments, the prediction engine 170 is configured to apply a prediction head that includes one or more fully connected layers that transform the prediction feature tensor into a logit vector having one logit value for each label in the prediction target label space.

In some embodiments, the prediction engine 170 is configured to generate the model output as the logit vector and stores the model output together with the prediction configuration record identifier, the model version identifier, and the graph snapshot identifier.

In some embodiments, the prediction engine 170 is configured to generate an auxiliary model output that includes an embedding of the prediction feature tensor produced by a bottleneck layer in the prediction head.

In some embodiments, the prediction engine 170 is configured to generate an ensemble model output using a plurality of predictive models and a combination rule. In some embodiments, the prediction engine 170 selects a set of predictive models that include a graph-based predictive model, a text-based predictive model that consumes clause-level pooled representations, a metadata-based predictive model that consumes graph-derived numeric features, a combination thereof and the like.

In some embodiments, the prediction engine 170 is configured to generate a model output from each predictive model by applying each predictive model to an associated feature tensor constructed using the learned representation snapshot and stores a set of per-model logit vectors. In some embodiments, the prediction engine 170 is configured to compute an ensemble logit vector by applying a combination rule that includes averaging logit vectors across predictive models with weights specified in the prediction configuration record and stores the ensemble logit vector as the model output in the matter repository 115.

In some embodiments, the prediction engine 170 is configured to generate multi-task model outputs for a plurality of prediction targets associated with the target legal matter. In some embodiments, the prediction engine 170 is configured to select a plurality of prediction tasks that include outcome classification, reversal classification, damages range classification, time-to-resolution regression, and settlement likelihood classification, a combination thereof and the like. For each prediction task, the prediction engine 170 selects a task-specific prediction head and applies the task-specific prediction head to a shared backbone representation derived from the matter-level representation and stores a task-specific model output for the prediction task. In some embodiments, the prediction engine 170 is configured to store, in the matter repository 115 for each task-specific model output, a task identifier, a target event type identifier, and a logit vector or a scalar value based on the prediction task, a combination thereof and the like.

In some embodiments, the prediction engine 170 is configured to store the model output with provenance and reproducibility metadata. In some embodiments, the prediction engine 170 is configured to store, in the matter record, a model output record that includes a model output identifier, a pointer to the model output logit vector, the prediction configuration record identifier, the model version identifier, the learned representation snapshot identifier, the entity tracking snapshot identifier, and the graph snapshot identifier, a combination thereof and the like.

In some embodiments, the prediction engine 170 is configured to generate a model output content hash computed across a canonical serialization of the logit vector and associated identifiers and stores the model output content hash together with a timestamp and the intake identifier, a combination thereof and the like, in the matter record.

In some embodiments, a calibration engine 175 is configured to transform the model output into a calibrated prediction output.

In some embodiments, the calibration engine 175 is configured to generate a prediction output with coverage control for a target legal matter based on the calibrated prediction output.

In some embodiments, the calibration engine 175 is configured to retrieve, from the matter record, the model output record that includes the logit vector generated by the prediction engine 170 together with a prediction configuration record that specifies a target event type, a prediction target label space, a combination thereof and the like. In some embodiments, the calibration engine 175 is further configured to retrieve a calibration configuration record that specifies a calibration method, a calibration dataset identifier, a calibration update policy, and a target coverage parameter, a combination thereof and the like, from the matter repository 115.

In some embodiments, the calibration engine 175 is configured to associate the calibration configuration record identifier with a model version identifier, a learned representation snapshot identifier, a graph snapshot identifier for reproducibility, a combination thereof and the like.

In some embodiments, the calibration engine 175 is configured to generate the calibrated prediction output by converting the logit vector into calibrated probability values. In some embodiments, the calibration engine 175 is configured to convert the logit vector into an uncalibrated probability vector by applying a normalization transform. In some embodiments, the normalization transform includes a softmax transform across logits for a multi-class label space and a sigmoid transform for a binary label space, a combination thereof and the like.

In some embodiments, the calibration engine 175 is configured to apply a calibration mapping to the uncalibrated probability vector by selecting calibration parameters stored for the model version identifier and applying the calibration parameters to generate a calibrated probability vector.

In some embodiments, the calibration engine 175 is configured to apply temperature scaling by dividing each logit value by a learned temperature value, recomputing a normalized probability vector, and storing the resulting values as the calibrated probability vector.

In some embodiments, the calibration engine 175 normalizes a model output score for a candidate label using temperature scaling prior to generating the calibrated prediction output, e.g., \tilde{s}ₑ=s_{c}/T. In this example, s_{c} denotes a score value for candidate label c derived from the model output record, T denotes a temperature value stored in a calibration configuration record, and \tilde{s}_{c} denotes a normalized score value used to compute calibrated probability values

In some embodiments, the calibration engine 175 is configured to apply a Platt scaling mapping by computing an affine transform of a logit value using a learned slope and a learned intercept, then applying a sigmoid transform to generate a calibrated probability value.

In some embodiments, the calibration engine 175 is configured to apply an isotonic regression mapping by mapping an uncalibrated probability value through a monotonic piecewise-linear function learned from calibration data.

In some embodiments, the calibration engine 175 is configured to store the calibrated probability vector, in the matter record, as a calibrated prediction output record associated with the model output identifier and the calibration configuration record identifier.

In some embodiments, the calibration engine 175 is configured to compute nonconformity scores for conformal prediction using calibration data and the calibrated prediction output.

In some embodiments, the calibration engine 175 is configured to retrieve a calibration dataset that includes historical matter records and corresponding ground-truth outcome labels for the target event type and retrieves, for each calibration dataset matter record, a corresponding calibrated probability vector generated using the same model version identifier and calibration configuration record identifier.

In some embodiments, the calibration is configured to compute, for each calibration dataset matter record, a nonconformity score by selecting a score function specified in the calibration configuration record and applying the score function to the calibrated probability vector and the ground-truth outcome label.

In some embodiments, the calibration is configured to compute a nonconformity score as one minus a calibrated probability assigned to a ground-truth label. In some embodiments, the calibration is configured to compute a nonconformity score as a negative log of a calibrated probability assigned to a ground-truth label.

In some embodiments, the calibration engine 175 is configured to store a nonconformity score list together with a calibration dataset identifier and a timestamp in the calibrated prediction output record.

In some embodiments, the calibration engine 175 is configured to compute a conformal threshold for the target coverage parameter and to generate a coverage-controlled prediction set for the target legal matter.

In some embodiments, the calibration engine 175 sorts the nonconformity score list in ascending order and selects a quantile value based on the target coverage parameter and a number of calibration samples, then assigns the quantile value as a conformal threshold. In some embodiments, the calibration is configured to apply the score function to the calibrated probability vector for the target legal matter to compute, for each candidate label in the prediction target label space, a label-specific nonconformity value.

In some embodiments, the calibration engine 175 computes, for a candidate label y, a conformal p-value based on a calibration dataset, e.g.,

$${p}_{y} ( {x}^{∖ *} ) = \frac{\vert \{ i ∈ {𝒥}_{cal} : A ( {x}_{i} , {y}_{i} ) \geq A ( {x}^{∖ *} , y ) \} \vert + 1}{\vert {𝒥}_{cal} \vert + 1} .$$

In this example, [symbol] _{cal} denotes an index set corresponding to the calibration dataset, (xᵢ,yᵢ) denotes a calibration example and its ground-truth label, A(⋅) denotes a nonconformity function that maps an input-label pair to a nonconformity value, and x^{\*} denotes an input corresponding to the target legal matter. In some embodiments, the prediction output comprises a prediction set that includes labels y having p_{y}(x^{\*}) satisfying a threshold determined by a target coverage parameter value.

In some embodiments, the calibration engine 175 is configured to compute the conformal threshold as a quantile of the stored nonconformity score list. For example, for a calibration dataset having n calibration samples and a target coverage parameter α, the calibration engine 175 selects an index k=┌(n+1)(1−α)┐ and assigns q as the k-th smallest nonconformity value in the sorted nonconformity score list, wherein q is stored as the conformal threshold. In this example, n denotes a number of calibration samples represented in the calibration dataset identifier, α denotes the target coverage parameter value, and q denotes the conformal threshold used to form the prediction set.

In some embodiments, the calibration engine 175 defines the prediction set Γ_{α}(x^{\*}) for the target legal matter as Γ_{α}(x^{\*})={y∈ [symbol] :A(x^{\*},y)≤q}. In this example, [symbol] denotes the prediction target label space, A(x^{\*},y) denotes the label-specific nonconformity value computed for candidate label y for the target legal matter x^{\*}, and q denotes the conformal threshold computed for the target coverage parameter α.

In some embodiments, the calibration engine 175 is configured to generate a prediction set by including the candidate label in the prediction set when the label-specific nonconformity value satisfies the conformal threshold and excluding the candidate label when the label-specific nonconformity value violates the conformal threshold.

In some embodiments, the calibration engine 175 is configured to store the prediction set as a prediction output record in the matter repository 115. In some embodiments, the prediction output record includes a prediction output identifier, the prediction set, the conformal threshold, the target coverage parameter, a combination thereof and the like.

In some embodiments, the calibration engine 175 is configured to generate local conformal prediction outputs using similarity-based calibration subsets. In some embodiments, the calibration engine 175 is configured to retrieve an auxiliary model output embedding for the target legal matter and selects a neighbor set from the calibration dataset by computing similarity values between the auxiliary model output embedding and auxiliary embeddings for the calibration dataset, then selecting a set of nearest neighbors based on the similarity values.

In some embodiments, the calibration engine 175 is configured to compute a local nonconformity score list based on the nearest neighbors. In some embodiments, the calibration engine 175 is configured to compute a local conformal threshold using the local nonconformity score list and the target coverage parameter. In some embodiments, the calibration engine 175 is configured to generate a local prediction set for the target legal matter using the local conformal threshold. In some embodiments, the calibration engine 175 is configured to store, in the matter record, the local prediction set as a local prediction output record linked to the prediction output identifier.

In some embodiments, the calibration engine 175 is configured to store calibrated prediction outputs and coverage-controlled prediction outputs with provenance and reproducibility metadata. In some embodiments, the calibration engine 175 is configured to store, in the matter record, a calibration output record that includes the calibrated probability vector, the prediction set, the conformal threshold, the target coverage parameter, the model output identifier, the calibration configuration record identifier, the calibration dataset identifier, a calibration output content hash computed across a canonical serialization of the stored values and corresponding identifiers, a combination thereof and the like. In some embodiments, the calibration engine 175 is configured to store the calibration output record together with a timestamp and the intake identifier.

In some embodiments, a text prediction engine 180 is configured to generate text hypotheses associated with a target legal matter.

In some embodiments, the text prediction engine 180 is configured to retrieve, from the matter record, one or more learned representations that include a matter-level representation, pooled representations for STRUCTURAL_UNIT nodes, and final node representations for ISSUE nodes and HOLDING nodes, a combination thereof and the like. In some embodiments, the text prediction engine 180 is configured to retrieve a text task configuration record that specifies a text target type, a text output format, a candidate set size, and a decoding specification, a combination thereof and the like.

In some embodiments, the text prediction engine 180 is configured to generate a ranked list of text hypotheses by applying a text generation model to an input context that includes selected clause text from the de-identified canonical text package and selected graph-derived attributes that include citation treatment records and role annotation records, a combination thereof and the like. In some embodiments, the text prediction engine 180 is configured to store the ranked list of text hypotheses in the matter record together with rank positions and generation scores.

In some embodiments, the text prediction engine 180 is configured to construct a text generation input context using deterministic selection rules. In some embodiments, the text prediction engine 180 selects a set of supporting STRUCTURAL_UNIT nodes by identifying STRUCTURAL_UNIT nodes linked to a target ISSUE node through SUPPORTS edges and selecting clause-level STRUCTURAL_UNIT nodes that have role labels corresponding to ISSUE_SEGMENT and ARGUMENT_SEGMENT with role label confidence scores exceeding a threshold, a combination thereof and the like. In some embodiments, the text prediction engine 180 is configured to retrieve clause text for the selected STRUCTURAL_UNIT nodes from the de-identified canonical text package and concatenates the clause text in a deterministic order determined by span identifier ordering. In some embodiments, the text prediction engine 180 augments the clause text with structured metadata that includes tribunal identifiers, a target event type, citation records for cited authorities referenced by the selected clause text, and treatment labels stored on TREATMENT edges incident to the selected STRUCTURAL_UNIT nodes, a combination thereof and the like. In some embodiments, the text prediction is configured to store the constructed text generation input context as a text context record linked to the text task configuration record identifier in the matter repository 115.

In some embodiments, the text prediction engine 180 is configured to generate text hypotheses. In some embodiments, the text prediction engine 180 is configured to generate a plurality of candidate text hypotheses by decoding token sequences from the text generation model using the decoding specification, wherein the decoding specification specifies beam search with a beam width value, a maximum token length value, and a stopping criterion, a combination thereof and the like. In some embodiments, the text prediction engine 180 is configured to assign, to each candidate text hypothesis, a generation score that includes a log-likelihood score computed as a sum of token log probabilities produced by the text generation model and a length normalization term computed from a token count of the candidate text hypothesis, a combination thereof and the like. In some embodiments, the text prediction engine 180 is configured to rank the candidate text hypotheses by sorting candidate text hypotheses according to the generation score.

In some embodiments, the text prediction engine 180 is configured to store the ranked list of text hypotheses the generation score, a rank position value, a combination thereof and the like, in the matter record.

In some embodiments, a conformal text engine 185 configured to generate a coverage-controlled text set from the text hypotheses.

In some embodiments, the conformal text engine 185 is configured to compute text nonconformity values for the ranked list of text hypotheses using a text calibration dataset.

In some embodiments, the conformal text engine 185 is configured to retrieve a text calibration dataset that includes historical matters and associated reference text outputs for the text target type and retrieves, for each historical matter, a ranked list of candidate text hypotheses generated using the same text task configuration record identifier. In some embodiments, the conformal text is configured to compute, for each historical matter, a text nonconformity value for a reference text output by locating a position of the reference text output within the ranked list of candidate text hypotheses and assigning a rank-based nonconformity value derived from the position. In some embodiments, the conformal text is configured to compute a text nonconformity value by computing a negative log-likelihood score for the reference text output under the text generation model and assigning the negative log-likelihood score as the text nonconformity value. In some embodiments, the conformal text is configured to store, in the matter repository 115, a text p-value vector indexed by the conformal text output record identifier and, in some embodiments, the text p-value vector is further indexed by a hypothesis identifier and a rank position value, a combination thereof and the like.

In some embodiments, the conformal text engine 185 is configured to compute a text conformal threshold for a target coverage parameter and to generate a coverage-controlled text set for the target legal matter. In some embodiments, the conformal text engine 185 sorts the text nonconformity list and selects a quantile value based on the target coverage parameter and a number of text calibration samples, then assigns the quantile value as the text conformal threshold.

In some embodiments, the conformal text engine 185 is configured to compute, for each candidate text hypothesis in the ranked list of text hypotheses for the target legal matter, a candidate text nonconformity value by applying a text score function specified in a text calibration configuration record to a generation score and a rank position value for the candidate text hypothesis, a combination thereof and the like.

In some embodiments, the conformal text engine 185 is configured to generate a coverage-controlled text set by including a candidate text hypothesis in the coverage-controlled text set when the candidate text nonconformity value satisfies the text conformal threshold and excluding the candidate text hypothesis when the candidate text nonconformity value violates the text conformal threshold.

In some embodiments, the conformal text engine 185 is configured to compute the text conformal threshold as a quantile of a text nonconformity list computed across a text calibration dataset. For example, for nₜₑₓₜ text calibration samples and a target coverage parameter α, the conformal text engine 185 selects kₜₑₓₜ=┌(nₜₑₓₜ+1)(1−α)┐ and assigns qₜₑₓₜ as the kₜₑₓₜ-th smallest text nonconformity value, wherein qₜₑₓₜ is stored as the text conformal threshold. In some embodiments the conformal text engine 185 defines a coverage-controlled text set

$${Γ}_{α}^{text} ( {x}^{{∖}^{*}} )$$

by including a candidate text hypothesis t when Aₜₑₓₜ(x^{\*},t)≤qₜₑₓₜ, wherein Aₜₑₓₜ(x^{\*},t)denotes a text nonconformity value computed for the candidate text hypothesis.

In some embodiments, the conformal text engine 185 is configured to store the coverage-controlled text set in the matter record together with the text conformal threshold and the target coverage parameter. In some embodiments, the conformal text engine 185 is configured to store text hypotheses and conformal text outputs with provenance and reproducibility metadata. In some embodiments, the conformal text engine 185 is configured to store, in the matter record, a conformal text output record that includes the ranked list of text hypotheses, the coverage-controlled text set, the text conformal threshold, the target coverage parameter, the text task configuration record identifier, the text calibration dataset identifier, and a content hash computed across a canonical serialization of the stored values and corresponding identifiers, a combination thereof and the like. In some embodiments, the conformal text is configured to store the conformal text output record together with a timestamp and the intake identifier, thereby enabling downstream stages to retrieve a selected conformal text output record corresponding to a selected text task configuration record stored in the matter record.

In some embodiments, an explanation engine 190 is configured to generate explanation artifacts for a prediction output produced for a target legal matter and to store the explanation artifacts in the matter record.

In some embodiments, the explanation engine 190 is configured to retrieve, from the matter record, a model output record, a calibrated prediction output record, and a prediction output record that includes a prediction set and p-values, together with a learned representation snapshot, a graph snapshot, and an embedding snapshot, a combination thereof and the like. In some embodiments, the explanation engine 190 is configured to retrieve provenance pointers that link prediction features to node identifiers, edge identifiers, span identifiers, and clause identifiers, a combination thereof and the like.

In some embodiments, the explanation engine 190 is configured to generate feature attribution values for a prediction output by computing contributions of input components to the model output.

In some embodiments, the explanation engine 190 is configured to identify a prediction feature tensor used by the prediction engine 170 and decomposes the prediction feature tensor into feature groups that include a matter-level representation component, a target-scope representation component, a graph-derived numeric feature component, and an entity group statistic component, a combination thereof and the like.

In some embodiments, the explanation engine 190 is configured to compute a baseline feature tensor by setting each feature group to a baseline value stored in the explanation configuration record and recomputes a baseline model output by applying the predictive model to the baseline feature tensor.

In some embodiments, the explanation engine 190 is configured to compute a feature group contribution value by substituting a single feature group from the prediction feature tensor into the baseline feature tensor while retaining remaining feature groups at baseline values, applying the predictive model to generate a perturbed model output, and computing a difference value between the perturbed model output and the baseline model output for each candidate label in the prediction target label space.

In some embodiments, the explanation engine 190 is configured to store feature group contribution values together with the corresponding feature group identifiers and candidate labels in the matter record.

In some embodiments, the explanation engine 190 is configured to generate node-level and edge-level attribution values using graph-aware backpropagation through the predictive model. In some embodiments, the explanation engine 190 is configured to identify node identifiers and edge identifiers that contributed to the prediction feature tensor based on provenance pointers stored in the prediction configuration record and computes gradient-based attribution values by computing partial derivatives of a selected logit value in the model output with respect to final node representations and selected edge embedding vectors, a combination thereof and the like. In some embodiments, the explanation engine 190 is configured to aggregate the node-level attribution values by summing attribution values across representation dimensions for each node identifier and aggregates edge-level attribution values by summing attribution values across representation dimensions for each edge identifier.

In some embodiments, the explanation engine 190 is configured to select a ranked set of explanatory nodes by sorting node identifiers according to node-level attribution values and selects a ranked set of explanatory edges by sorting edge identifiers according to edge-level attribution values.

In some embodiments, the explanation engine 190 is configured to store a node attribution map that links each ranked node identifier to a node type label and a set of node attributes. In some embodiments, the explanation engine 190 is configured to store an edge attribution map that links each ranked edge identifier to an edge type label and a set of edge attributes.

In some embodiments, the explanation engine 190 is configured to generate text-grounded explanation snippets by mapping node-level attributions to clause text in the de-identified canonical text package. In some embodiments, the explanation is configured to identify, for a ranked STRUCTURAL_UNIT node, one or more clause identifiers and span identifiers linked to the STRUCTURAL_UNIT node and retrieves corresponding text spans from the de-identified canonical text package. In some embodiments, the explanation engine 190 is configured to construct an explanation snippet by extracting a contiguous span window that includes a selected clause text portion, one or more citation strings associated with cited authorities referenced in the clause text portion, and one or more surrogate tokens associated with referenced entities, a combination thereof and the like. In some embodiments, the explanation engine 190 associates each explanation snippet with a node attribution value and a role label associated with the clause unit. In some embodiments, the explanation engine 190 stores the explanation snippets as an explanation snippet record linked to the prediction output identifier in the matter record.

In some embodiments, the explanation engine 190 is configured to generate citation-based explanations by identifying cited authorities that most influenced a prediction output. In some embodiments, the explanation engine 190 selects a ranked set of AUTHORITY nodes based on aggregated attribution values computed for STRUCTURAL_UNIT nodes incident to CITES edges and TREATMENT edges that target the AUTHORITY nodes. In some embodiments, the explanation engine 190 is configured to generate an authority explanation record for each selected AUTHORITY node by retrieving the canonical reporter label, the normalized pin cite representation, and the treatment label and treatment confidence score stored on a corresponding TREATMENT edge, then associating the retrieved values with a contribution score derived from attribution values. The explanation is configured to store a ranked authority explanation set that includes authority explanation records and stores, for each authority explanation record, a provenance pointer to span identifiers in which the authority was cited.

In some embodiments, the explanation engine 190 is configured to generate counterfactual prediction outputs by applying structured perturbations to a matter representation and recomputing downstream artifacts prior to applying a prediction engine 170.

In some embodiments, the explanation engine 190 is configured to retrieve a counterfactual configuration record that specifies a perturbation type, a perturbation scope, and a perturbation magnitude, a combination thereof and the like.

In some embodiments, the explanation engine 190 is configured to generate a counterfactual matter variant by applying a perturbation operation that edits one or more components of the matter record while preserving de-identification, wherein the perturbation operation includes removing a selected STRUCTURAL_UNIT node from a graph snapshot, replacing a treatment label stored on a selected TREATMENT edge, removing a selected AUTHORITY node and associated CITES edges, modifying a temporal ordering by editing a normalized event timestamp on a selected EVENT node, and removing a selected ENTITY_GROUP node membership link, a combination thereof and the like. In some embodiments, the explanation engine 190 recomputes, for the counterfactual matter variant, affected embedding artifacts by applying the embedding engine 150 to generate a counterfactual embedding snapshot for graph elements impacted by the perturbation operation and recomputes affected learned representation artifacts by applying the graph learning engine 160 to generate a counterfactual learned representation snapshot for the counterfactual matter variant. In some embodiments, the explanation engine 190 then recomputes a counterfactual model output by applying the prediction engine 170 to the counterfactual learned representation snapshot and recomputes a counterfactual calibrated prediction output and a counterfactual prediction output using the calibration engine 175, thereby generating a counterfactual prediction output that is comparable to a baseline prediction output under a shared calibration configuration record.

In some embodiments, the explanation engine 190 is configured to quantify counterfactual impact values and to store a counterfactual report in the matter record.

In some embodiments, the explanation is configured to compute a counterfactual impact value by computing a difference between a baseline calibrated probability vector and a counterfactual calibrated probability vector for each candidate label and computing a difference between a baseline prediction set and a counterfactual prediction set based on label inclusion changes, a combination thereof and the like.

In some embodiments, the explanation is configured to store a counterfactual report that includes an identification of applied perturbations, baseline outputs, counterfactual outputs, counterfactual impact values, and provenance pointers to graph elements affected by the perturbations, a combination thereof and the like. The explanation is configured to store the counterfactual report together with a timestamp and the intake identifier, thereby enabling downstream stages to retrieve a selected counterfactual report corresponding to a selected prediction output identifier stored in the matter record.

In some embodiments, an output assembly engine 195 is configured to generate a prediction package for a target legal matter and to deliver the prediction package to a client device under an authorization policy.

In some embodiments, the output assembly engine 195 is configured to retrieve, from the matter record, a calibrated prediction output record, a prediction output record that includes a prediction set and p-values, a conformal text output record that includes a coverage-controlled text set, and an explanation snippet record and counterfactual report generated by an explanation engine 190, a combination thereof and the like. In some embodiments, the output assembly engine 195 is configured to retrieve a delivery configuration record that specifies a delivery channel, a recipient identifier, an encryption profile identifier, and an access control policy identifier, a combination thereof and the like. In some embodiments, the output assembly engine 195 is configured to assemble the prediction package by selecting a set of output fields specified by the delivery configuration record. In some embodiments, the output assembly engine 195 is configured to store the prediction package record linked to a prediction output identifier in the matter record.

In some embodiments, the output assembly engine 195 is configured to generate a presentation-layer prediction output by transforming internal records into a client-consumable schema.

In some embodiments, the output assembly engine 195 is configured to transform a calibrated probability vector into a label display set by selecting one or more candidate labels in the prediction target label space and generating a display record for each selected candidate label that includes a calibrated probability value, a p-value, and an inclusion indicator that identifies whether the candidate label is included in the prediction set, a combination thereof and the like.

In some embodiments, the output assembly engine 195 is configured to transform the coverage-controlled text set into a text rationale display set by generating a text rationale record for each included text hypothesis and associating each text rationale record with a rank position and a generation score stored in the conformal text output record.

In some embodiments, the output assembly engine 195 is configured to transform explanation artifacts into an explanation display set by mapping node attribution values and explanation snippets to clause-level display segments and associating each clause-level display segment with cited authority identifiers and treatment labels referenced in the clause-level display segment, a combination thereof and the like.

The output assembly is configured to store the resulting presentation-layer prediction output as a prediction package payload linked to a prediction package record.

In some embodiments, the output assembly engine 195 is configured to enforce access control for sensitive mappings and to selectively re-identify entities under a permitted policy. The output assembly engine 195 receives an access token that includes a principal identifier and an authorization scope identifier and validates the access token by verifying a token signature, validating an expiration value, and checking that the authorization scope identifier satisfies an access control policy associated with the delivery configuration record. In some embodiments, when the access control policy permits re-identification, the output assembly engine 195 is configured to retrieve, from a secure vault, a mapping record that links an EntityID to a sensitive span value and substitutes the sensitive span value for a corresponding surrogate token, a EntityID placeholder, a combination thereof and the like, in a prediction package payload portion identified as re-identifiable. In an embodiment, clause text retrieved from the de-identified canonical text package includes surrogate tokens, and normalized semantic records that include normalized issue text and normalized holding text include EntityID placeholders, and the output assembly engine 195 performs substitution using a mapping that resolves each surrogate token to a corresponding redaction record that identifies an EntityID. In some embodiments, when the access control policy denies re-identification, the output assembly engine 195 is configured to retain surrogate tokens and EntityID placeholders in the prediction package payload and excludes mapping records from the prediction package payload.

In some embodiments, the output assembly engine 195 is configured to generate an audit log record for output delivery and to store the audit log record in the matter record.

In some embodiments, the output assembly engine 195 is configured to generate the audit log record that includes a prediction package record identifier, a principal identifier, a recipient identifier, a delivery timestamp, a delivery channel identifier, and a content hash computed across a canonical serialization of the prediction package payload, a combination thereof and the like. In some embodiments, the output assembly is configured to store the audit log record together with a policy identifier and the intake identifier, thereby enabling later verification of what content was delivered under what authorization policy.

In some embodiments, the output assembly engine 195 is configured to encrypt and deliver the prediction package to a client device. In some embodiments, the output assembly engine 195 is configured to select an encryption profile based on an encryption profile identifier and retrieves an encryption key from a key management system under a key access policy. In some embodiments, the output assembly engine 195 is configured to encrypt the prediction package payload by applying an authenticated encryption operation that produces a ciphertext and an authentication tag and stores the ciphertext together with an encryption metadata record that includes a key identifier, a nonce value, an algorithm identifier, a combination thereof and the like. In some embodiments, the output assembly engine 195 is configured to transmit the ciphertext to a client device using the delivery channel and stores a delivery confirmation record that includes a transmission identifier, a delivery status indicator, and a timestamp, a combination thereof and the like.

In some embodiments, the output assembly engine 195 is configured to provide a secure retrieval interface for prediction packages. In some embodiments, the output assembly engine 195 is configured to generate a retrieval token associated with the prediction package record identifier and stores the retrieval token together with an expiration value and a permitted operation set. In some embodiments, the output assembly engine 195 is configured to receive a retrieval request that includes the retrieval token and validates the retrieval request by verifying the retrieval token, checking that the expiration value is not exceeded, and checking that a requested operation is included in the permitted operation set, a combination thereof and the like. In some embodiments, the output assembly engine 195 is configured to return the prediction package payload to the client device in encrypted form and records the retrieval request in the audit log record, thereby providing controlled access to the prediction package under the access control policy.

In some embodiments, the prediction package includes a portfolio of matters. In some embodiments, the portfolio includes a plurality of matter identifiers corresponding to a plurality of matter records stored in the matter repository 115. In some embodiments, the portfolio is defined by (i) a portfolio descriptor received via an API endpoint or user interface, (ii) a saved filter that selects matter records based on one or more matter context attributes, or (iii) an automated grouping keyed to a client identifier, a practice group identifier, a jurisdiction identifier, a judge identifier, a filing date range, a combination thereof and the like.

In some embodiments, for each matter identifier in the portfolio and for a specified target event type, the analytics system 100 is configured to retrieve, from the corresponding matter record, the calibrated prediction output generated by the calibration engine 175, the prediction output having coverage control. In some embodiments, the analytics system 100 is configured to compute, for each matter in the portfolio, a matter-level risk contribution value based on (i) the calibrated prediction output, the prediction output and (ii) an exposure value stored in the matter record, a combination thereof and the like.

In some embodiments, the exposure value represents an estimated cost, potential damages, expected settlement amount, reserve amount, fee budget, or other financial impact parameter. In some embodiments, the analytics system 100 is configured to aggregate the matter-level risk contribution values across the portfolio to generate a portfolio risk metric, including one or more of: an expected portfolio loss value, a probability that aggregate loss exceeds a threshold value, a distribution of aggregate loss values generated by sampling from the calibrated prediction outputs, a tail-risk value corresponding to a specified percentile of the distribution, a scenario-specific portfolio risk value computed under one or more constraint assumptions, a combination thereof and the like.

In some embodiments, the prediction package includes a portfolio risk report record. In some embodiments, the portfolio risk report includes the portfolio descriptor, the plurality of matter identifiers, the target event type, one or more portfolio risk metrics, and provenance metadata that identifies, for each matter identifier, the corresponding prediction output identifier, the calibration configuration record identifier used to generate the calibrated prediction output, the prediction output, a combination thereof and the like.

In some embodiments, the portfolio risk report is stored in the matter repository 115 in association with a timestamp, a model version identifier, a coverage parameter value used to produce coverage-controlled prediction outputs, thereby enabling reproducible portfolio risk quantification for a selected portfolio snapshot.

In some embodiments, the secure vault, the output assembly engine 195, a combination thereof and the like, are configured to enforce rate limiting and re-identification risk controls for queries that involve sensitive mappings or that could enable differencing attacks across repeated aggregate queries.

In some embodiments, the analytics system 100 is deployed as a network-accessible service that exposes one or more application programming interface (API) endpoints configured to receive requests associated with matter ingestion, graph construction, prediction generation, and delivery of a prediction package. In some embodiments, an API gateway is configured to authenticate each request using an access token that includes a principal identifier and an authorization scope identifier and to route the request to one or more of the intake engine 110, the graph construction engine 140, the prediction engine, the calibration engine, the explanation engine, and the output assembly engine, a combination thereof and the like. In some embodiments, the API gateway is configured to validate request payloads against a canonical schema, enforce request size limits and rate limits under an authorization policy, and write an API access log record that includes a request identifier, a timestamp, a principal identifier, an endpoint identifier, and a response status indicator, a combination thereof and the like.

In some embodiments, the API endpoints include one or more of: (i) a graph encoding endpoint configured to initiate construction or retrieval of a heterogeneous graph for a target legal matter, including an endpoint formatted as POST/graph/encode that accepts a matter identifier and returns a graph snapshot identifier; (ii) a prediction endpoint configured to generate a model output and a calibrated prediction output for a target legal matter, including an endpoint formatted as POST/predict that accepts a matter identifier and a target event type and returns a prediction output identifier; (iii) a calibration endpoint configured to generate a prediction output with coverage control, including an endpoint formatted as POST/calibrate that accepts a model output identifier, a target coverage parameter, and a calibration configuration record identifier and returns a prediction set and a conformal threshold; (iv) a text endpoint configured to generate text hypotheses and a coverage-controlled text set, including an endpoint formatted as POST /text/hypotheses, POST/text/conformal, a combination thereof and the like; (v) an explanation endpoint configured to generate explanation artifacts, including an endpoint formatted as POST/explain that accepts a prediction output identifier and returns explanation snippet records and, in some embodiments, a counterfactual report; and (vi) a retrieval endpoint configured to return a prediction package payload under an authorization policy, including an endpoint formatted as GET /prediction/{prediction_output_identifier}, GET/package/ {prediction_package_record_identifier}, a combination thereof and the like.

In some embodiments, one or more endpoints are restricted endpoints configured to perform sensitive operations under elevated authorization scopes. For example, when an authorization policy permits re-identification, the system exposes a restricted endpoint formatted as POST/vault/reidentify that accepts an EntityID and a permitted scope identifier and returns a sensitive span value, wherein the restricted endpoint enforces access control, audit logging, and rate limiting as described herein, a combination thereof and the like. In some embodiments, the system exposes an audit endpoint formatted as POST/audit/query configured to retrieve audit log records for a specified request identifier, principal identifier, or time window, wherein the audit endpoint returns only fields permitted by the authorization policy, a combination thereof and the like.

In some embodiments, the system is configured to monitor model performance and operational health by computing one or more monitoring metrics and storing the monitoring metrics in a monitoring repository. In some embodiments, the monitoring metrics include one or more of request latency, error rate, endpoint throughput, queue depth, matter ingestion success rate, graph construction success rate, prediction generation success rate, and secure vault access rate, a combination thereof and the like. In some embodiments, the system is configured to generate an alert when one or more operational metrics violate a threshold defined in a monitoring configuration record, and to store an alert record that includes the violated metric identifier, the measured value, a threshold value, and a timestamp, a combination thereof and the like.

In some embodiments, the system is configured to detect drift and calibration degradation using monitoring computations applied to observed inputs and observed outcomes. In some embodiments, drift detection includes computing feature distribution statistics for one or more of matter context attributes, graph-derived numeric features, and learned representations, then comparing the statistics to baseline statistics associated with a model version identifier using a drift score function that includes a population stability index, a divergence value, and a two-sample test statistic, a combination thereof and the like. In some embodiments, calibration monitoring includes computing a calibration metric value for a calibrated probability vector, wherein the calibration metric value includes an expected calibration error, a Brier score, a reliability curve summary statistic, a combination thereof and the like, and comparing the calibration metric value to a baseline value stored for the model version identifier. In some embodiments, coverage tracking includes computing an empirical coverage value by measuring a fraction of matters for which a ground-truth label is included in a prediction set generated under a target coverage parameter, then comparing the empirical coverage value to the target coverage parameter and generating an alert when a deviation exceeds a tolerance threshold, a combination thereof and the like.

In some embodiments, the monitoring repository stores a monitoring snapshot that includes a model version identifier, a calibration configuration record identifier, a target coverage parameter, one or more drift metric values, one or more calibration metric values, one or more coverage deviation values, and a timestamp, a combination thereof and the like. In some embodiments, the system is configured to trigger a remediation operation when monitoring indicates degraded behavior, wherein the remediation operation includes updating calibration parameters, refreshing a calibration dataset, selecting a different calibration configuration record identifier, rolling back to a prior model version identifier, or escalating to a human review queue, a combination thereof and the like.

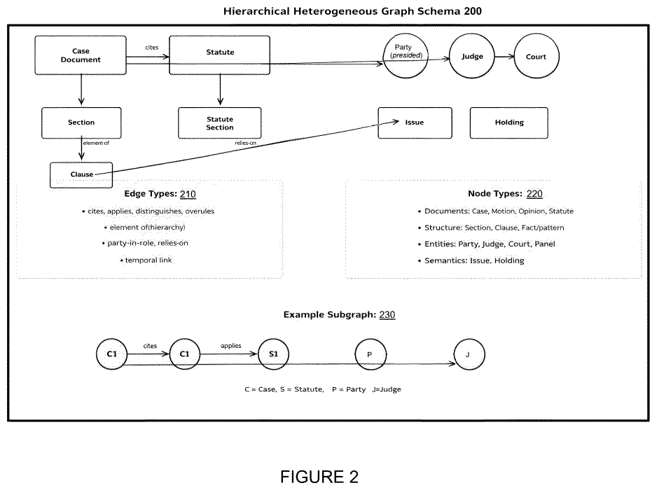

FIG. 2 is a diagram illustration of hierarchical heterogeneous graph schema 200, implemented in accordance with an embodiment.

In some embodiments, the hierarchical heterogeneous graph schema 200 is initialized by the graph construction engine 140. In some embodiments, the hierarchical heterogeneous graph schema 200 serializes matter artifacts stored in a matter record into heterogeneous graph nodes, heterogeneous graph edges, associated attributes, a combination thereof and the like.

In some embodiments, the hierarchical heterogeneous graph schema 200 includes edge types 210, node types 220 and an example subgraph 230.

In some embodiments, the edge types 210 defines a plurality of edges in the hierarchical heterogenous graph schema 200. In some embodiments, the edge types 210 include hierarchy relationships, citation and treatment relationships, role and reliance relationships, temporal relationships, a combination thereof and the like.

In some embodiments, the node types 220 define a plurality of nodes in the hierarchical heterogeneous graph schema 200. In some embodiments, the node types 220 includes document artifacts, structural artifacts, semantic artifacts, authority artifacts, entity artifacts, temporal artifacts, a combination thereof and the like.

In some embodiments, the edge types 210 correspond to typed linkage operations generated by the graph construction engine 140. In some embodiments, hierarchical relationships labeled as “element-of” in FIG. 2 are encoded using CONTAINS edges and PARENT_OF edges that link DOCUMENT nodes to document-unit STRUCTURAL_UNIT nodes and link parent STRUCTURAL_UNIT nodes to descendant STRUCTURAL_UNIT nodes according to parent unit identifiers stored in the structured matter representation, a combination thereof and the like. In some embodiments, citation relationships labeled as “cites” in FIG. 2 are encoded using CITES edges from citing STRUCTURAL_UNIT nodes to AUTHORITY nodes, and treatment semantics including “applies,” “distinguishes,” and “overrules” are encoded using TREATMENT edges that assign a treatment label and treatment confidence score as edge attributes while preserving base citation provenance on corresponding CITES edges, a combination thereof and the like.

In some embodiments, role and reliance relationships illustrated in FIG. 2 (e.g., “party-in-role,” “presided,” “relies-on”) are encoded using typed edges and edge attributes derived from matter context fields, role annotation records, issue linkage records, holding linkage records, a combination thereof and the like, including SUPPORTS edges that link ISSUE nodes and HOLDING nodes to supporting STRUCTURAL_UNIT nodes and RESOLVES edges that link HOLDING nodes to ISSUE nodes with compatibility score values stored as edge attributes, a combination thereof and the like

In some embodiments, the node types 220 correspond to node types generated and stored in the matter record, including one or more DOCUMENT nodes representing source artifact descriptors (e.g., a case document, motion, opinion, statute, common law, regulation, administrative decision, a combination thereof and the like), one or more STRUCTURAL_UNIT nodes representing structural units derived from canonical text packages (e.g., document units, section units, subsection units, paragraph units, clause units, a combination thereof and the like), and one or more semantic nodes including ISSUE nodes and HOLDING nodes generated from normalized legal semantic records.

In some embodiments, the node types 220 further include one or more AUTHORITY nodes corresponding to cited authorities derived from citation records and one or more ENTITY nodes keyed by EntityID together with one or more MENTION nodes keyed by MentionID to represent de-identified entity references in the de-identified canonical text package. For example, parties, judges, courts, panels, a combination thereof and the like, are representable as ENTITY nodes with corresponding mention occurrences represented as MENTION nodes linked to STRUCTURAL_UNIT nodes via MENTIONS edges and linked to ENTITY nodes via REFERS_TO edges, a combination thereof and the like.

In some embodiments, temporal link concepts that may be encoded using temporal nodes and edges derived from a matter timeline stored in the matter record. In some embodiments, the graph construction engine 140 generates EVENT nodes for events in the matter timeline and generates REFERENCES_EVENT edges linking DOCUMENT nodes to EVENT nodes based on linkages stored in the matter timeline and generates PRECEDES edges among EVENT nodes to encode an ordered event sequence, wherein temporal attributes including normalized event timestamps, time delta values, and sequence delta values are assigned as edge attributes to enable downstream traversal that respects time ordering, a combination thereof and the like.

In some embodiments, the example subgraph 230 is an instance of the hierarchical heterogeneous graph schema 200 for a target legal matter.

In some embodiments, the example subgraph 230 includes a DOCUMENT node corresponding to a case document and one or more STRUCTURAL_UNIT nodes corresponding to sections and clauses, together with a citation relationship from a citing STRUCTURAL_UNIT node to an AUTHORITY node corresponding to a cited statute, and a treatment relationship indicating that the statute is applied, distinguished, overruled, a combination thereof and the like. In some embodiments, the example subgraph 230 further includes entity references for parties and adjudicators represented using ENTITY nodes and MENTION nodes, wherein the entity references are linked to relevant STRUCTURAL_UNIT nodes and document provenance through typed edges and provenance pointers stored in the matter record, a combination thereof and the like.

In some embodiments, the graph construction engine 140 stores the graph schema together with a schema identifier and a version identifier and applies the graph schema when generating typed node records and typed edge records for a target legal matter.

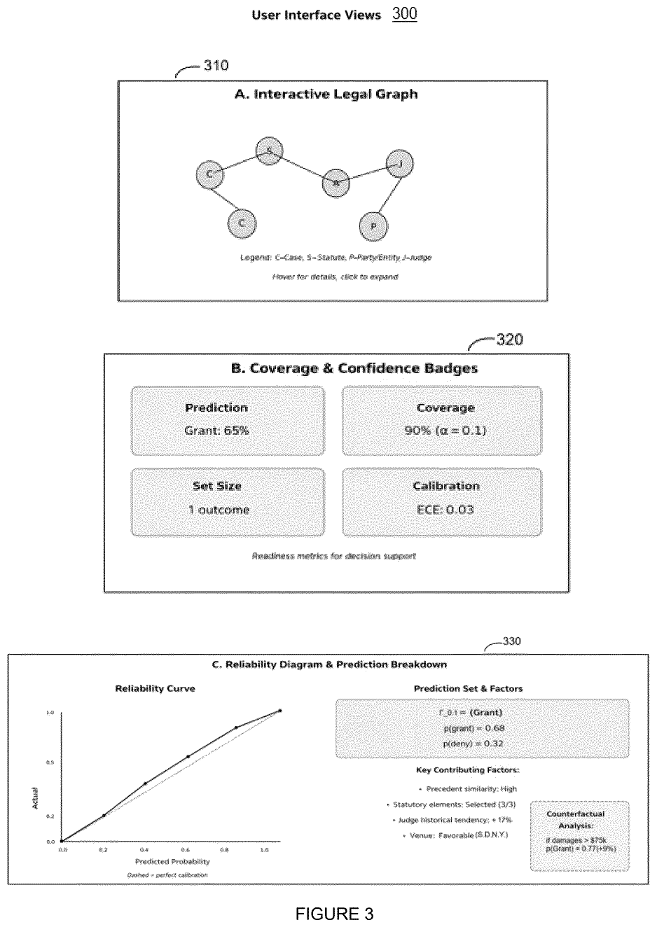

FIG. 3 is a diagram illustration of user interface views 300, implemented in accordance with an embodiment.

In some embodiments, the output assembly engine is configured to generate, for display on a client device, the user interface views 300.

In some embodiments, the user interface views includes an interactive legal graph view 310, coverage and confidence badges view 320 and a reliability diagram and prediction breakdown view 330.

In some embodiments, the output assembly engine is configured to construct each user interface view by transforming the matter record into a client-consumable schema that includes a label display set derived from the calibrated prediction output, an inclusion indicator derived from the prediction output record that includes the prediction set, p-values derived from conformal processing, explanation artifacts derived from an explanation snippet record, and counterfactual artifacts derived from a counterfactual report, a combination thereof and the like.

In some embodiments, the interactive legal graph view 310 includes a visualization of heterogeneous graph elements generated for the target legal matter. In some embodiments, the output assembly engine is configured to retrieve, from the matter record, a graph snapshot including typed node records and typed edge records and to render a display-layer graph in which displayed nodes correspond to a selected subset of heterogeneous graph node types including DOCUMENT nodes, EVENT nodes, ISSUE nodes, HOLDING nodes, STRUCTURAL_UNIT nodes, AUTHORITY nodes, ENTITY nodes, and MENTION nodes, a combination thereof and the like. In some embodiments, the output assembly engine is configured to render displayed edges corresponding to a selected subset of heterogeneous graph edge types including CONTAINS edges, PARENT_OF edges, SUPPORTS edges, RESOLVES edges, CITES edges, TREATMENT edges, REFERENCES_EVENT edges, PRECEDES edges, MENTIONS edges, REFERS_TO edges, a combination thereof and the like.

In some embodiments, the interactive legal graph view 310 is configured to support user interactions that include hover actions, click actions, and expansion actions that reveal node attributes and edge attributes including provenance pointers, span identifiers, clause identifiers, treatment labels, treatment confidence scores, compatibility scores, normalized event timestamps, a combination thereof and the like, wherein the revealed attributes are retrieved from the matter record using the identifiers stored in the graph snapshot.

In some embodiments, the coverage and confidence badges view 320 includes readiness metrics derived from the calibrated prediction output record and the prediction output record. In some embodiments, the output assembly engine is configured to generate a prediction badge that includes a selected candidate label and a calibrated probability value obtained from the calibrated probability vector stored as part of the calibrated prediction output record. In some embodiments, the output assembly engine is configured to generate a coverage badge that includes a target coverage parameter and an inclusion indicator determined from the prediction set stored in the prediction output record, wherein the inclusion indicator identifies whether a displayed candidate label is included in the prediction set generated using a conformal threshold. In some embodiments, the output assembly engine is configured to generate a set-size badge that includes a set size value computed as a count of candidate labels included in the prediction set. In some embodiments, the output assembly engine is configured to generate a calibration badge that includes one or more calibration quality values computed for the calibration configuration record, including an expected calibration error value, a reliability deviation value, a combination thereof and the like, wherein the calibration quality values are retrieved from a calibration output record linked to the calibration configuration record identifier.

In some embodiments, the reliability diagram and prediction breakdown view 330 includes calibration performance together with a breakdown of the prediction set and explanatory factors. In some embodiments, the output assembly engine is configured to generate a reliability curve by binning calibrated probability values into probability bins and computing, for each probability bin, an empirical outcome frequency value determined from calibration data associated with the calibration dataset identifier, then plotting empirical outcome frequency values against calibrated probability values to illustrate calibration consistency. In some embodiments, the output assembly engine is configured to display, in a prediction set panel, an explicit representation of the prediction set generated under the target coverage parameter, together with calibrated probability values for candidate labels and p-values associated with candidate labels, wherein the p-values are retrieved from a prediction output record that includes p-values and the prediction set. In some embodiments, the output assembly engine is configured to display, in a contributing factors panel, a ranked set of contributing factors derived from explanation artifacts stored in the matter record, including feature group contribution values, node attribution values, edge attribution values, explanation snippets mapped to clause-level display segments, cited authority identifiers, treatment labels, a combination thereof and the like.

In some embodiments, the reliability diagram and prediction breakdown view 330 further includes a counterfactual analysis derived from a counterfactual report stored in the matter record. In some embodiments, the output assembly engine is configured to display a counterfactual panel that identifies applied perturbations specified in the counterfactual report together with corresponding counterfactual outputs that include a counterfactual calibrated probability vector and a counterfactual prediction set, and impact values computed as differences relative to baseline outputs, a combination thereof and the like. In some embodiments, the output assembly engine is configured to associate each displayed counterfactual artifact with provenance pointers that identify affected graph elements including node identifiers, edge identifiers, span identifiers, clause identifiers, a combination thereof and the like, thereby enabling the client device to navigate from a counterfactual panel element to a corresponding portion of the interactive legal graph view 310 and to corresponding explanation snippets grounded in the de-identified canonical text package.

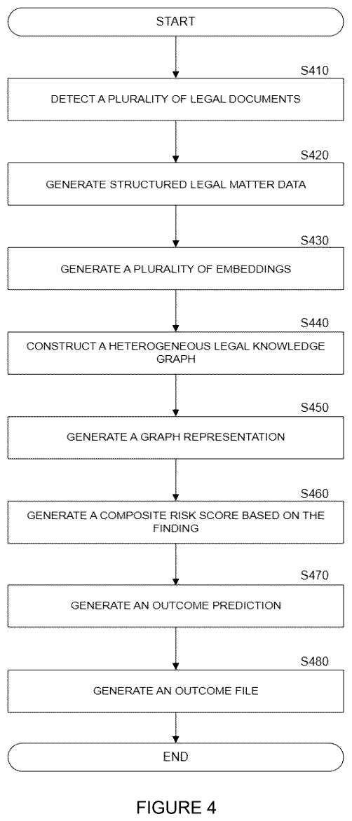

FIG. 4 is an example flowchart of a method for processing case-related electronic documents to generate an output file, implemented in accordance with an embodiment.

At S410, a plurality of legal documents are received. In some embodiments, the plurality of legal documents are electronic files. In some embodiments, the plurality of legal documents are received from one or more endpoints. In some embodiments, the one or more endpoints include (i) electronic court filing systems, docketing systems, court calendar services, and tribunal portals, (ii) document repositories and matter management systems, (iii) electronic mail inboxes and secure message inboxes configured to receive legal documents, (iv) secure file transfer endpoints and application programming interface (API) feeds configured to provide case-related records, a combination thereof and the like. In some embodiments, receiving the plurality of legal documents includes authenticating to a selected endpoint using scoped credentials, retrieving a set of files using deterministic retrieval parameters that include a matter identifier, a tribunal identifier, a case number, a filing date range, a docket entry range, a combination thereof and the like, and generating, for each received legal document, an associated source artifact descriptor that includes a retrieval timestamp, a file format identifier, and a document fingerprint, a combination thereof and the like. In some embodiments, the plurality of legal documents include docket entries, pleadings, motions, exhibits, declarations, discovery materials, court orders, judicial opinions, statutes, common law, regulations, administrative decisions, transcript records, judge profiles, court calendars, a combination thereof and the like.

For example, an intake engine is configured to retrieve a set of docket PDFs and associated docket metadata for a target legal matter from an electronic court filing system using scoped credentials, receives an additional motion exhibit as an attachment from a secure message inbox, and records for each received file a retrieval timestamp, a file format identifier, and a document fingerprint in a corresponding source artifact descriptor.

At S420, a normalized text representation is generated. In some embodiments, generating the normalized text representation includes parsing the plurality of legal documents. In some embodiments, the normalized text span includes ordered text spans, each ordered text span associated with a span identifier and a provenance pointer identifying an originating legal document among the plurality of legal documents. In some embodiments, parsing includes extracting raw text from each legal document when available in a text layer, performing optical character recognition (OCR) on image-based pages when the text layer is absent or uncertain, and performing document parsing operations that detect section boundaries, caption fields, headings, paragraph boundaries, and citation blocks, a combination thereof and the like. In some embodiments, generating the normalized text representation includes canonicalization operations that remove non-semantic boilerplate, normalize whitespace, standardize numbering tokens, convert typographic variants into canonical characters, and preserve layout cues as metadata associated with ordered text spans, a combination thereof and the like. In some embodiments, each ordered text span is assigned an offset range, a parent section identifier, and a provenance pointer to the source artifact descriptor for the originating legal document, thereby enabling deterministic traceability from each span identifier to an originating legal document, a combination thereof and the like.

For example, the intake engine is configured to parse a received PDF pleading by extracting a text layer for pages that include selectable text, applies OCR to image-only pages containing scanned signatures, segments the resulting intermediate representation into ordered text spans corresponding to caption lines and paragraph blocks, assigns each span a span identifier and offset range, and assigns a provenance pointer for each span identifier to the source artifact descriptor corresponding to the pleading.

At S430, a versioned snapshot of the normalized text representation is stored. In some embodiments, the versioned snapshot is stored together with a timestamp, a content hash, a snapshot identifier, a provenance pointer set that identifies one or more originating legal documents through corresponding source artifact descriptors, a combination thereof and the like. In some embodiments, the versioned snapshot, the timestamp, the content hash, the snapshot identifier, the provenance pointer set, a combination thereof and the like, are stored in a matter repository. In some embodiments, the content hash is computed across a canonical serialization of the normalized text representation including span identifiers and ordered text spans, thereby enabling later verification that a retrieved normalized text representation matches the stored versioned snapshot by recomputing the content hash, a combination thereof and the like. In some embodiments, the snapshot identifier is a fixed-length identifier derived from the content hash together with an intake identifier, thereby enabling deterministic referencing of the stored versioned snapshot by downstream stages and by an output package without requiring reconstruction steps, a combination thereof and the like.

For example, the intake engine is configured to store, in the matter repository, a versioned snapshot record that includes the normalized text representation, a timestamp, a content hash computed across the ordered text spans and span identifiers, a snapshot identifier derived from the content hash and an intake identifier, and provenance pointers that reference the source artifact descriptors for the docket PDF and the exhibit attachment.

At S440, a heterogeneous graph representation is constructed based on the normalized text representation. In some embodiments, the heterogeneous graph representation includes a plurality of nodes and a plurality of edges, wherein the plurality of nodes represent document structure and legal entities, and wherein the plurality of edges represent citations and timeline relationships between the plurality of nodes. In some embodiments, constructing the heterogeneous graph representation includes generating typed node records that include DOCUMENT nodes corresponding to source artifact descriptors, STRUCTURAL_UNIT nodes corresponding to document units, section units, paragraph units, and clause units derived from the ordered text spans, AUTHORITY nodes corresponding to cited authorities extracted from citation strings, ENTITY nodes corresponding to de-identified entities keyed by EntityID values, ISSUE nodes and HOLDING nodes corresponding to normalized legal semantic records, EVENT nodes corresponding to matter timeline events, a combination thereof and the like. In some embodiments, constructing the heterogeneous graph representation includes generating typed edge records that include CONTAINS edges, PARENT_OF edges, CITES edges, TREATMENT edges, REFERENCES_EVENT edges, PRECEDES edges, MENTIONS edges, REFERS_TO edges, SUPPORTS edges, and RESOLVES edges, a combination thereof and the like. In some embodiments, each node record and each edge record includes a provenance pointer to one or more span identifiers, clause identifiers, source artifact descriptors, a combination thereof and the like, thereby preserving traceability from the heterogeneous graph representation back to the normalized text representation and the originating legal documents, a combination thereof and the like.

For example, at S440, the graph construction engine is configured to generate a DOCUMENT node for a retrieved court order, generates clause-level STRUCTURAL_UNIT nodes for ordered text spans in a “Discussion” section, generates AUTHORITY nodes for detected citations to precedent, generates EVENT nodes for docket events ordered by filing date, and generates CITES edges and PRECEDES edges linking those nodes based on citation span references and the matter timeline.

At S450, relation-aware message passing is performed on the heterogeneous graph representation to generate a learned representation. In some embodiments, the relation-aware message passing includes initializing node representations using node attributes and embedding vectors derived from span text referenced by span identifiers, then iteratively updating node representations by propagating messages across edge types using relation-specific transforms, a combination thereof and the like. In some embodiments, the relation-aware message passing includes grouping edges by edge type label and applying a relation transform that multiplies a source node representation by a relation-specific weight matrix and adds a relation-specific bias vector to generate a relation-transformed message, a combination thereof and the like. In some embodiments, the relation-aware message passing includes computing attention weights for inbound edges to a target node by applying an attention scoring network to an attention input vector that includes a relation-transformed source representation, a target node representation, and an edge embedding vector derived from edge attributes, then normalizing attention scores across inbound edges, a combination thereof and the like.

In some embodiments, the relation-aware message passing includes aggregating normalized relation-transformed messages to compute an updated node representation and repeating the update across a plurality of message-passing layers to generate final node representations. In some embodiments, the learned representation includes one or more of final node representations, pooled representations across STRUCTURAL_UNIT hierarchies, a document-level pooled representation, and a matter-level representation generated using document-level pooled representations ordered according to EVENT nodes and PRECEDES edges, a combination thereof and the like.

For example, the graph learning engine is configured to perform relation aware message passing that propagates information from AUTHORITY nodes to STRUCTURAL_UNIT nodes through CITES edges and TREATMENT edges, propagates temporal information through PRECEDES edges between EVENT nodes, and produces a matter-level representation by pooling document-level representations with larger weights assigned to more recent EVENT nodes.

At S460, a model output is generated by applying a predictive model to the learned representation. In some embodiments, the predictive model includes a prediction head that maps a selected learned representation into a logit vector having one logit value for each label in a prediction target label space, a combination thereof and the like. In some embodiments, applying the predictive model includes selecting a target scope representation by retrieving one or more learned representations associated with a target event type and corresponding node types that include an ISSUE node, a HOLDING node, a DOCUMENT node, an EVENT node, a STRUCTURAL_UNIT node, a combination thereof and the like, then combining the target scope representation with a matter-level representation to produce a prediction feature tensor. In some embodiments, the prediction head includes one or more fully connected layers that transform the prediction feature tensor into the logit vector, thereby generating the model output as the logit vector.

In some embodiments, the model output is stored in association with a model output identifier, a model version identifier, a graph snapshot identifier, and a learned representation snapshot identifier for reproducibility, a combination thereof and the like.

For example, the prediction engine is configured to retrieve a matter-level representation and a target-scope representation corresponding to a selected EVENT node representing a motion hearing, concatenates graph-derived numeric features derived from citation neighborhood statistics, applies a prediction head to produce a logit vector for an outcome label space, and stores the logit vector as a model output record with identifiers that reference the learned representation snapshot and the graph snapshot.

At S470, the model output is calibrated to generate a calibrated probability vector. In some embodiments, calibrating the model output includes converting the logit vector into an uncalibrated probability vector using a normalization transform that includes a softmax transform for a multi-class label space and a sigmoid transform for a binary label space, a combination thereof and the like. In some embodiments, calibrating the model output includes applying a calibration mapping selected by a calibration configuration record to generate a calibrated probability vector, wherein the calibration mapping includes temperature scaling, Platt scaling, isotonic regression, a combination thereof and the like.

In some embodiments, the calibrated probability vector is stored as a calibrated prediction output record associated with the model output identifier and the calibration configuration record identifier, together with a timestamp and a content hash computed across a canonical serialization of calibrated values and associated identifiers, a combination thereof and the like.

For example, at S470, the calibration engine is configured to convert the stored logit vector into an uncalibrated probability vector using a softmax transform, applies temperature scaling using a learned temperature value specified for the model version identifier, and stores the resulting calibrated probability vector in the matter repository together with the model output identifier and a calibration configuration record identifier.

At S480, an outcome prediction is generated based on the learned representation, calibrated probability, a combination thereof and the like. In some embodiments, generating the outcome prediction includes generating a prediction output that includes a selected label, a ranked label set, a prediction set, a combination thereof and the like, determined using the calibrated probability vector. In some embodiments, generating the outcome prediction includes applying coverage control using conformal prediction by computing a nonconformity score function on calibration data and selecting a conformal threshold for a target coverage parameter, then including candidate labels whose label-specific nonconformity values satisfy the conformal threshold, a combination thereof and the like. In some embodiments, the outcome prediction includes a prediction set together with one or more of a target coverage parameter, a conformal threshold, and p-values for candidate labels computed using stored nonconformity values, a combination thereof and the like. In some embodiments, the outcome prediction is stored as a prediction output record linked to the calibrated prediction output record and the model output record, a combination thereof and the like.

For example, the calibration engine is configured to use a stored nonconformity score list computed from historical matters for the same target event type, selects a conformal threshold for a target coverage parameter, generates a prediction set that includes a subset of outcome labels whose nonconformity values satisfy the threshold under the calibrated probability vector for the target legal matter, and stores the resulting prediction output record with the conformal threshold and the target coverage parameter.

At S490, an output file is generated as a prediction package. In some embodiments, the prediction package includes the outcome prediction, the content hash, a snapshot identifier corresponding to the stored versioned snapshot of the normalized text representation, a timestamp, a model version identifier, a calibration configuration record identifier, a graph snapshot identifier, a learned representation snapshot identifier, a combination thereof and the like. In some embodiments, the content hash included in the prediction package is the same content hash stored with the versioned snapshot at S430, thereby directly linking the prediction package to the stored versioned snapshot of the normalized text representation without additional conversion steps, a combination thereof and the like. In some embodiments, the prediction package includes one or more provenance pointers that identify originating legal documents by referencing the source artifact descriptors associated with the versioned snapshot record identified by the snapshot identifier, a combination thereof and the like. In some embodiments, the prediction package includes a verification payload that includes the snapshot identifier and the content hash so that a recipient system can retrieve, from the matter repository, the versioned snapshot record and verify integrity by recomputing the content hash across the retrieved normalized text representation, a combination thereof and the like.

For example, the output assembly engine is configured to generate a prediction package file that contains the prediction set produced at S480, includes the snapshot identifier and the content hash corresponding to the stored versioned snapshot record from S430, includes identifiers for the model output record and the calibrated prediction output record, and includes provenance pointers referencing the source artifact descriptors for the docket entries and court order documents that contributed span text to the normalized text representation used to construct the heterogeneous graph representation, a combination thereof and the like.

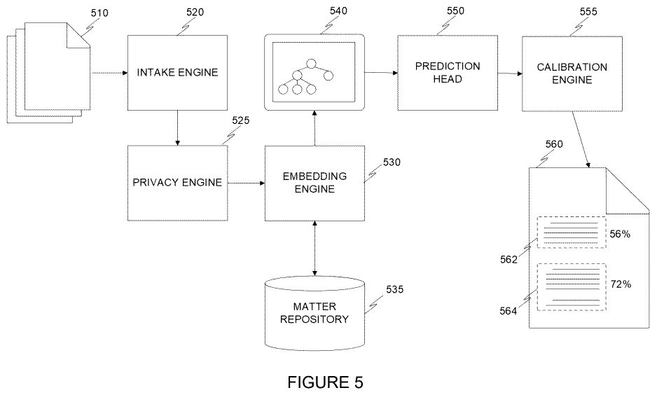

In some embodiments, FIG. 5 illustrates an example end-to-end processing flow for generating a prediction output for a target legal matter from one or more incoming legal sources. As shown, one or more legal source artifacts 510 are received by an intake engine 520. In some embodiments, the intake engine 520 is configured to generate, validate, and normalize structured matter context attributes for the target legal matter and to populate or update a matter record stored in a matter repository 535, a combination thereof and the like. In some embodiments, the intake engine 520 is further configured to retrieve one or more legal source artifacts associated with the target legal matter and to store corresponding source artifact descriptors and canonical text packages in association with the matter record, a combination thereof and the like.

In some embodiments, the intake engine 520 provides one or more canonicalized legal source artifacts and associated metadata to a privacy engine 525. The privacy engine 525 is configured to transform a canonical text package into a de-identified canonical text package by detecting sensitive spans, assigning redaction type labels, and replacing the sensitive spans with deterministic surrogate tokens that preserve document-scoped referential consistency, a combination thereof and the like. In some embodiments, the privacy engine 525 stores, in the matter repository 535, de-identified text artifacts and redaction records that include span identifiers, character offset ranges, surrogate tokens, and de-identified identifiers such as EntityID values and MentionID values, a combination thereof and the like.

In some embodiments, an embedding engine 530 is configured to retrieve, from the matter repository 535, one or more de-identified canonical text packages, structural units, graph elements, and associated provenance pointers, and to generate vector representations for the retrieved artifacts. In some embodiments, the embedding engine 530 generates node embedding vectors and edge embedding vectors for heterogeneous graph elements and stores embedding artifacts as part of an embedding snapshot in the matter repository 535, a combination thereof and the like. In some embodiments, the embedding engine 530 provides embedding artifacts to a learned representation stage 540 that is configured to generate learned representations for the target legal matter from the heterogeneous graph and embedding artifacts using message passing across typed edges, pooling across structural hierarchies, or both, a combination thereof and the like.

In some embodiments, a prediction head 550 consumes one or more learned representations from representation stage 540 to generate a model output for the target legal matter. In some embodiments, the model output comprises a logit vector or an uncalibrated probability vector over a prediction target label space, a combination thereof and the like. In some embodiments, a calibration engine 555 transforms the model output into a calibrated prediction output by converting logits to uncalibrated probabilities and applying one or more calibration mappings to produce calibrated probability values, a combination thereof and the like. In some embodiments, the calibration engine 555 further generates a prediction output by applying coverage control, including generating a prediction set and, in some embodiments, associating p-values with candidate labels or candidate text hypotheses, a combination thereof and the like. As shown, an output artifact 560 includes one or more prediction items 562, 564, each associated with a corresponding calibrated probability value or other calibrated score suitable for presentation, a combination thereof and the like.

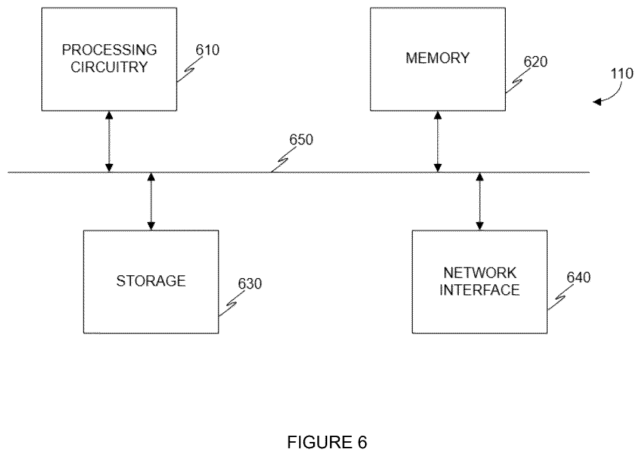

FIG. 6 is an example schematic diagram of an intake engine 110 according to an embodiment. The intake engine 110 includes, according to an embodiment, a processing circuitry 610 coupled to a memory 620, a storage 630, and a network interface 640. In an embodiment, the components of the intake engine 110 are communicatively connected via a bus 650.

In certain embodiments, the processing circuitry 610 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 620 is a volatile memory (e.g., random access memory, etc.), a non-volatile memory (e.g., read only memory, flash memory, etc.), a combination thereof and the like. In some embodiments, the memory 620 is an on-chip memory, an off-chip memory, a combination thereof and the like. In certain embodiments, the memory 620 is a scratch-pad memory for the processing circuitry 610.

In one configuration, software for implementing one or more embodiments disclosed herein is stored in the storage 630, in the memory 620, in a combination thereof and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 610, cause the processing circuitry 610 to perform the various processes described herein, in accordance with an embodiment.

In some embodiments, the storage 630 is a magnetic storage, an optical storage, a solid-state storage, a combination thereof and the like, and is realized, according to an embodiment, as a flash memory, as a hard-disk drive, another memory technology, various combinations thereof, or any other medium which can be used to store the desired information.

The network interface 640 is configured to provide the intake engine 110 with communication with, for example, user device, client device, graphical user interface, dashboard, a combination thereof and the like, according to an embodiment.

It should be understood that the embodiments described herein are not limited to the specific architecture illustrated in FIG. 6, and other architectures may be equally used without departing from the scope of the disclosed embodiments.

Furthermore, in certain embodiments a matter repository 115, a privacy engine 120, a structure engine 130, a graph construction engine 140, an embedding engine 150, a graph learning engine 160, an entity tracking engine 165, a prediction engine 170, a calibration engine 175, a text prediction engine 180, a conformal text engine 185, an explanation engine 190, an output assembly engine 195, may be implemented with the architecture illustrated in FIG. 6. In other embodiments, other architectures may be equally used without departing from the scope of the disclosed embodiments.

As used herein, a language model refers to a computational model configured to process linguistic input and to generate, evaluate, or otherwise operate on sequences of linguistic units, such as characters, sub-words, words, tokens, symbols, or combinations thereof, by estimating probabilistic relationships among such units.

Language models, as described herein, may include large language models (LLMs), small language models (SLMs), and other neural or non-neural language modeling systems, without limitation as to model size, parameter count, architecture, or training methodology. Non-limiting examples of language models include transformer-based models such as GPT-family models, Claude-family models, BERT-family models, T5, BART, and derivatives or variants thereof, as well as functionally equivalent models developed in the future.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for processing case-related electronic documents to generate an output file, comprising:
receiving a plurality of legal documents as electronic files that are associated with a legal matter;
parsing the plurality of legal documents to generate a normalized text representation, wherein the normalized text representation includes ordered text spans, each ordered text span associated with a span identifier and a provenance pointer identifying an originating legal document among the plurality of legal documents;
storing a versioned snapshot of the normalized text representation together with a timestamp and a content hash;
constructing a heterogeneous graph representation based on the normalized text representation, wherein the heterogeneous graph representation includes a plurality of nodes and a plurality of edges, wherein the plurality of nodes represent document structure and legal entities, and wherein the plurality of edges represent citations and timeline relationships between the plurality of nodes;
performing relation-aware message passing on the heterogeneous graph representation to generate a learned representation;
generating a model output by applying a predictive model to the learned representation;
calibrating the model output to generate a calibrated probability vector;
generating an outcome prediction for the legal matter based on the learned representation and the calibrated probability vector; and
generating the output file as a prediction package that includes the outcome prediction and the content hash.

2. The method of claim 1, further comprising:
detecting a sensitive span in the normalized text representation;
classifying a redaction type for the sensitive span generating surrogate tokens based on the redaction type; and
replacing the sensitive span with the surrogate tokens.

3. The method of claim 2, further comprising:
generating an entity identifier in response to the sensitive span including an entity;
generating a mention identifier, wherein the mention identifier represents a location of the sensitive span; and
storing a mapping between the entity identifier and a sensitive span value in a secure vault, wherein access to the secure vault is subject to a control policy and audit logging.

4. The method of claim 1, wherein the plurality of nodes includes at least one document node type and at least one structural unit node type corresponding to the ordered text spans, and the plurality of edges comprises at least one citation edge type representing that a first node cites a second node, and at least one temporal edge type representing that a third node at a first time precedes a fourth node at a second time.

5. The method of claim 1, further comprising:
computing a first transformed message by applying a first transform to messages propagated along citation relationships represented by a first subset of the plurality of edges;
computing a second transformed message by applying a second transform to messages propagated along timeline relationships represented by a second subset of the plurality of edges; and
aggregating, for a node, the first transformed message and the second transformed message using attention weights computed from node representations and edge attributes.

6. The method of claim 1, further comprising:
defining a prediction target label space comprising a plurality of outcome labels for the legal matter, wherein generating the model output comprises generating a logit vector having a respective logit value for each outcome label in the prediction target label space.

7. The method of claim 6, further comprising:
calibrating the model output comprises converting the model output to an uncalibrated probability vector using a normalization transform and applying a calibration mapping to generate the calibrated probability vector; and
generating a coverage-controlled prediction set based on the calibrated probability vector and a target coverage parameter, and wherein the prediction package includes an inclusion indicator for whether a candidate label is included in the coverage-controlled prediction set.

8. The method of claim 1, further comprising:
identifying timestamps in the plurality of legal documents, wherein the timestamps correspond to filing date;
weighting the normalized text representation based on the filing date; and
generating a matter timeline by ordering docket events based on extracted filing dates and linking each docket event to at least one provenance pointer.

9. The method of claim 1, further comprising:
generating a counterfactual report by modifying at least one component of the heterogeneous graph representation;
recomputing a counterfactual calibrated probability vector;
computing a difference between the calibrated probability vector and the counterfactual calibrated probability vector; and
including the difference in the output file.

10. A non-transitory computer-readable medium storing a set of instructions for processing case-related electronic documents to generate an output file, the set of instructions comprising:
one or more instructions that, when executed by one or more processing circuitries of a device, cause the device to:
receive a plurality of legal documents as electronic files that are associated with a legal matter;
parse the plurality of legal documents to generate a normalized text representation, wherein the normalized text representation includes ordered text spans, each ordered text span associated with a span identifier and a provenance pointer identifying an originating legal document among the plurality of legal documents;
store a versioned snapshot of the normalized text representation together with a timestamp and a content hash;
construct a heterogeneous graph representation based on the normalized text representation, wherein the heterogeneous graph representation includes a plurality of nodes and a plurality of edges, wherein the plurality of nodes represent document structure and legal entities, and wherein the plurality of edges represent citations and timeline relationships between the plurality of nodes;
perform relation-aware message passing on the heterogeneous graph representation to generate a learned representation;
generate a model output by applying a predictive model to the learned representation;
calibrate the model output to generate a calibrated probability vector;
generate an outcome prediction for the legal matter based on the learned representation and the calibrated probability vector; and
generate the output file as a prediction package that includes the outcome prediction and the content hash.

11. A system for processing case-related electronic documents to generate an output file comprising:
a processing circuitry;
a memory, the memory containing instructions that, when executed by the processing circuitry, configure the system to:
receive a plurality of legal documents as electronic files that are associated with a legal matter;
parse the plurality of legal documents to generate a normalized text representation, wherein the normalized text representation includes ordered text spans, each ordered text span associated with a span identifier and a provenance pointer identifying an originating legal document among the plurality of legal documents;
store a versioned snapshot of the normalized text representation together with a timestamp and a content hash;
construct a heterogeneous graph representation based on the normalized text representation, wherein the heterogeneous graph representation includes a plurality of nodes and a plurality of edges, wherein the plurality of nodes represent document structure and legal entities, and wherein the plurality of edges represent citations and timeline relationships between the plurality of nodes;
perform relation-aware message passing on the heterogeneous graph representation to generate a learned representation;
generate a model output by applying a predictive model to the learned representation;
calibrate the model output to generate a calibrated probability vector;
generate an outcome prediction for the legal matter based on the learned representation and the calibrated probability vector; and
generate the output file as a prediction package that includes the outcome prediction and the content hash.

12. The system of claim 11, wherein the memory contains further instructions which when executed by the processing circuitry further configure the system to:
detect a sensitive span in the normalized text representation;
classify a redaction type for the sensitive span;
generate surrogate tokens based on the redaction type; and
replace the sensitive span with the surrogate tokens.

13. The system of claim 12, wherein the memory contains further instructions which when executed by the processing circuitry further configure the system to:
generate an entity identifier in response to the sensitive span including an entity;
generate a mention identifier, wherein the mention identifier represents a location of the sensitive span; and
store a mapping between the entity identifier and a sensitive span value in a secure vault, wherein access to the secure vault is subject to a control policy and audit logging.

14. The system of claim 11, wherein the one or more processors, when the plurality of nodes includes at least one document node type and at least one structural unit node type corresponding to the ordered text spans, and the plurality of edges, are configured to at least one citation edge type represent that a first node cites a second node, and at least one temporal edge type representing that a third node at a first time precedes a fourth node at a second time.

15. The system of claim 11, wherein the memory contains further instructions which when executed by the processing circuitry further configure the system to:
compute a first transformed message by applying a first transform to messages propagated along citation relationships represented by a first subset of the plurality of edges;
compute a second transformed message by applying a second transform to messages propagated along timeline relationships represented by a second subset of the plurality of edges; and
aggregate, for a node, the first transformed message and the second transformed message using attention weights computed from node representations and edge attributes.

16. The system of claim 11, wherein the memory contains further instructions which when executed by the processing circuitry further configure the system to:
define a prediction target label space comprising a plurality of outcome labels for the legal matter, wherein generating the model output comprises generating a logit vector having a respective logit value for each outcome label in the prediction target label space.

17. The system of claim 16, wherein the memory contains further instructions which when executed by the processing circuitry further configure the system to:
calibrate the model output comprises converting the model output to an uncalibrated probability vector using a normalization transform and applying a calibration mapping to generate the calibrated probability vector; and
generate a coverage-controlled prediction set based on the calibrated probability vector and a target coverage parameter, and wherein the prediction package includes an inclusion indicator for whether a candidate label is included in the coverage-controlled prediction set.

18. The system of claim 11, wherein the memory contains further instructions which when executed by the processing circuitry further configure the system to:
identify timestamps in the plurality of legal documents, wherein the timestamps correspond to filing date;
weight the normalized text representation based on the filing date; and
generate a matter timeline by ordering docket events based on extracted filing dates and linking each docket event to at least one provenance pointer.

19. The system of claim 11, wherein the memory contains further instructions which when executed by the processing circuitry further configure the system to:
generate a counterfactual report by modifying at least one component of the heterogeneous graph representation;
recompute a counterfactual calibrated probability vector;
compute a difference between the calibrated probability vector and the counterfactual calibrated probability vector; and
include the difference in the output file.
